(19) United States
(12) Patent Application Publication
(10) Pub. No.: US 2008/0318547 A1
(43) Pub. Date: Dec. 25, 2008

(54) COMMUNICATIONS NETWORK

(76) Inventors: Bernard L. Ballou, JR., Raleigh, NC (US); Charles Eric Hunter, Jefferson, NC (US); Timothy Richard Crocker, Cockwood (GB)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/194,368

(22) Filed: Aug. 19, 2008

Related U.S. Application Data
(63) Continuation of application No. 11/401,575, filed on Apr. 11, 2006.

(30) Foreign Application Priority Data
Apr. 11, 2005 (EP) EP 0 5252251.3

(51) Int. Cl. H04M 3/16

(52) U.S. Cl. 455/410; 455/422.1

(57) ABSTRACT

A distributed communications network comprising a plurality of nodes and a plurality of user devices, wherein each node comprises: a communications device for establishing bi-directional wireless communication with at least one user device, a communications device for establishing bi-directional communication with at least one other node; and a data processor in association with a local memory for storing information for presentation to users, and wherein at least one of the nodes further includes a communications device connected to a further communications network, and wherein nodes are grouped into clusters that cooperate with one another such that if a user requests information which is held in the local memory of a node within a cluster then the nodes cooperate to supply that information to the user and if a connection between a user and the further communications network is required, the nodes cooperate to establish it.

The present invention relates to communications networks, generally, and more particularly to a communications network is suited for bridging the gap between large capacity high data rate networks, such as networks typically installed by telephone operators to carry calls and data between large communities, such as towns and cities, and the individual end user. The present invention can be used to provide both plain old telephone services and high bandwidth data services to users.

Typically within a cable based telephone system, the connection between an individual user's telephone and an exchange can be considered as a combination of the following:
1) A single cable from the user's house to a nearby telephone pole. Other users typically have cables running to the pole;
2) A path, typically underground or in a multi-pair cable between poles, where a relatively modest number of cables are routed to a local connection/junction box;
3) A path from the junction box to the exchange, many hundreds of users may share this path; and
4) A path from the exchange to a trunk network, which forms a backbone of the telecommunication system.

Of these connections, the connections designated 1) and 2) above are costly to install since relatively expensive ground works are often required to deliver services to a small number of users.

Optical fiber communications technology has been accepted as a means for low signal loss communications at large data-carrying capacity rates. Until recently however, the cost of implementing optical fiber communications to the home has been prohibitive, especially due to the requirement for more expensive optical transmitters and receivers.

According to the present invention there is provided a distributed communications network comprising a plurality of nodes and a plurality of user devices, wherein each node comprises:
i.a communications device for establishing bi-directional wireless communication with at least one user device; and,
ii.a data processor in association with a local memory for storing information for presentation to users, and wherein at least one of the nodes further includes a communications device connected to a further communications network, and wherein nodes are grouped into clusters that cooperate with one another such that if a user requests information which is held in the local memory of a node within a cluster then the nodes cooperate to supply that information to the user and if a connection between a user and the further communications network is required, the nodes cooperate to establish it.

The node may further comprise a communications device for establishing bi-directional communication with at least one other node; however, as mentioned, may be stand-alone with a back haul connection (e.g., DSL, cable, optical fiber, GPRS, UV light at ≦280 nm wavelengths, etc.) to the further communications network, e.g., Internet.

It is thus possible to provide a communications network which is suited for providing a cost effective connection between a large communications network, such as the high bandwidth backbone of a regional or national telecommunications network or the Internet, and user. The user may be at their home or place of work, or traveling and equipped with devices configured with standard wireless communications technologies (implementing Bluetooth, IrDA, IEEE 802.11, GPRS (General Packet Radio Service) protocols for example).

Preferably, nodes within a first cluster can establish wireless contact with nodes in a second cluster via a wired (e.g., cable, optical fiber) or, wireless communications infrastructure.

Preferably, a node within a cluster and wishing to establish connection with the further communications network can communicate with that further communications network either through members of its own cluster or via the second cluster. Communication between nodes within a cluster may be established utilizing a wireless communications infrastructure at frequencies outside the KU band, e.g., above 20 GHz range or 65-75 GHz frequency range, for example, or, at optical frequencies via optical fiber connections between nodes. Preferably, the nodes can co-operate to form a cluster as a function of a cost penalty for relaying transmissions.

As clusters expand, they will overlap with neighboring clusters, and these clusters will start to coalesce into web or “sea of connectivity” in which requests for information can be sought outside of the cluster by using the multiple connection paths that become available. The network administrator or operator may seek to define clusters by giving each node within a cluster the same cluster identity or by using a unique identity given to each node to enable the operator to define which nodes are to group together to form a cluster. In an alternative scheme each node may define its own “ad hoc” cluster as a function, for example, of the number of nodes it can communicate with directly and the number of intervening nodes required to make contact with a specific node. Thus, each intervening node used to relay a communication is modeled as incurring a cost penalty and hence the clusters tend to limit themselves in size as a function of control parameters (cost penalties) defined by the node owner or operator. Further it may be that adjacent clusters have different owners or operators and hence such operators may agree financial charges for traffic passing between them on the basis of these computed cost penalties, or these cost penalties might be used to generate other third party charging, for instance to users requesting information.

To put this into perspective consider a typical housing estate of low occupancy dwellings. Typically the individual houses are spaced along the sides of roads. Telephone and data services are routed to each house via an individual cable. These cables are either buried or carried overhead to telephone poles, which support the wires to several houses. Some of the poles then route the individual cables down to below ground level whilst others take the connection further from pole to pole as individual pairs or multi-pair bundles, which are eventually terminated at a local node or a sub exchange. However new services are now frequently required within the home or office. These services include, but are not limited to, broadband Internet connectivity and multi-channel digital television. There is a limit to the data bandwidth that can delivered to the home or office on a conventional local loop copper pair using ADSL (asymmetric digital subscriber line) or DSL technology. Current solutions for providing increased capacity typically include fiber optic cables or high bandwidth copper co-axial or twisted pairs. In recent build areas conduits may have been installed through which the new cable or optical fiber may be pulled. However the conduits may not extend all the way to each property so some groundwork may still be required. There may also be technical limitations on the number of taps on to a cable or fiber to produce a termination for an individual user. In older areas without conduits ground works will be needed in addition to forming the terminations and these tend to be a disruptive and costly business. In contrast, the present invention enables most of the cabling to be dispensed with only one of the nodes within a cluster needing a “termination” to connect it, and hence the cluster, to the telephone/data/telecommunications network. Furthermore, it can be seen that as the clusters coalesce, then any individual home or office may be able to route to the telecommunications backbone via several terminations.

Preferably each node and a device with which it is in wireless communication, be it a user device or another node, can apply security measures to the communication to reduce the chance of the communication being intercepted and understood. The security measures may, as part of a non-exhaustive list, include encryption or use of a cipher or other code to scramble the message. For secure communications the sending and receiving units may cooperate to use a “one time pad” coding system where each portion of a communication is coded with a distinct code, and the code changes between portions. Typically portions will be single bytes, with each byte encoded by some simple and reversible mathematical process with a new byte from a code table. The codes in such a scheme are derived from code books or code tables which are random in nature and pre-agreed between the parties to the transaction.

Preferably a node further has the ability to direct its transmit, and optionally its receive wireless (radio) beams. This may be achieved by the use of multiple directional antennas, beam steering techniques or the use of electronically reconfigurable antennas, such as plasma antennas. Plasma antennas are known devices, but reference can be made to WO03/056660. The use of such directional antennas confers several benefits. Firstly the security of the wireless communication is enhanced because it becomes more difficult for an eavesdropper to intercept the signal if they are not positioned in the direction of the transmission lobe of the antenna. Secondly, given that the transmit antenna, and optionally the receive antenna, exhibits antenna gain then the transmit power may be reduced. This reduces RF interference from the devices and, given that the public has often been concerned about the health effects from the placement of nodes, reduces the RF power transmitted into the environment surrounding a node.

Preferably, each node of a cluster has a modular architecture permitting connectivity between a plurality of devices that provide for, among other things: data storage; data transmission, ability to receive various power inputs (e.g., 110 Vac, 220 Vac, photovoltaic, or other power supply means); protection from environmental conditions; the ability to generate local alarms and automatically notify emergency and other governmental agencies. Preferably, processing ability at a node is provided in the form of dedicated RISC-based processors and associated architectures as will be described hereinafter in greater detail.

Preferably the local memory provided at the node is formed of non-volatile memory and is able to retain data storage without external power, for example, by utilizing FLASH memory, or, where memory lifetime and speed is important, e.g., SRAM, where a constant voltage source is supplied (e.g., via battery). Where nodes are located indoors or in environmentally suitable locations, hard disks with long Mean Time Between Failures, or like devices are advantageously employed. In outdoor or environmentally harsh conditions, where temperature cycling and vibration can adversely effect the longevity of such devices (disk drives), solid state memory is preferred as storage size is rapidly increasing whilst cost is decreasing. The local memory is preferably used as a cache. High-speed DRAM (e.g., DDR RAM) is utilized as part of the core mode architecture as will be described in greater detail herein.

The local cache may hold several types of data. The cache may, for example, hold data concerning businesses, and preferably local businesses. The data may include, but is not limited to:

hours of business;

location;

services offered;

price details;

promotional offers; and

details of items available.

The above list should not be considered as being exhaustive.

For instance a node may store geographical data relevant to the area around the node or cluster and presents this information to a user's device.

A node may store data describing the layout of a building, and this data can be presented to a user's device such that a user can be given information about the building.

The information held in the cache may be organized in a searchable form. For example, the information may be represented using a mark up language such as XML (although other schemes for representing the information are available). This allows the data to be structured such that graphics and other media can be included within the document (which term should be construed broadly to include both text and deliverable multimedia content) or data offering. Additionally hyperlinks may be included such that the document can link to other documents or web pages.

XML and HTML are intrinsically searchable. However, in one aspect, the present invention uses a formal registry such that information can be classified in a way that is both precise and flexible. The use of the registry may require, or at least encourage, data providers to include predefined descriptors or definitions which may be thought of acting as a main category word. The main category word may then be modified by one or more optional parameters expressed, for example, in the form:

Attribute=argument

Where an attribute is a property that qualifies a main category word, and the argument that is assigned to the attribute assigns a value that is representative of the properties of the information that the registry entry indexes, i.e. that it relates to. The attributes are selected from a predefined list that is applicable to the main category word, and these are designed (and maintained) by the network administrator to allow ready and accurate cross comparison between entries. Thus, for example, a hotel may be entered in the registry as:

HOTEL,
establishment_name=“KINGS COURT HOTEL”, star_rating=3,
Bedrooms=25,restaurants=1,swimming_pool=1,training_room=1,
bedroom_001_one_person_bed_and_breakfast=$90,
bedroom_002_one_person_half_board=$120, . . .,
building_picture=filename(<path>/KINGSCOURT_EXTERIOR.jpg)

This entry defines that the hotel is called the “Kings Court Hotel”, and it is a 3 star hotel with 25 bedrooms, a restaurant, a swimming pool and a training room. Details of the individual bedrooms and tariffs are then presented.

These registry entries can be very long but the format is fixed and consistent, and can be easily parsed by a computer. The entries enable pertinent data to be expressed in an very succinct form. Thus all available rooms could be fisted together with their price. In a variant of the scheme, all rooms could be listed together with an availability flag or range indicator, thereby allowing automatic updating of the registry to be performed from the hotel's reservation and booking computer. Thus, in response to a request for information the node could search through its registry to find results that match the search criteria. Where multiple criteria are expressed, the node may combine the searches, for example using Boolean algebra, and match both content information parameters, and location and time based informational elements to find the results that match all the search criteria, or alternatively it could transmit those registry entries that match any one of the criteria to the user device such that the computational load of refining the search is borne by the user device.

Authoring tools may be provided by network operators to help validate that businesses are submitting their data in a form which should work with the nodes. These tools may validate that the entries for submission to the registry only contain the correct classifications. The tools may also validate that technically a document as submitted should be supportable by the nodes and browsers of the user devices.

Businesses choosing to advertise their presence using a communications system according to the present invention may upload their details to the registry of one or more nodes and may also upload a website to the cache of the node. Operators of the communications system may charge businesses for hosting the information in the cache. The charge may be a function of volume of memory occupied, time and duration for which the information should be offered to users, geographical proximity between a user and the business, and temporal significance of the business. If a user was seeking a restaurant, those restaurants which are geographically nearer a given user (given that the position of the restaurant is known and the position of the node is known) may be presented in preference to those restaurants which are further away or, alternatively, may be charged at a different, and probably lower, rate for hosting their information on a node. Similarly, if a restaurant's opening hours are such that, at the time a user makes an enquiry it is shut but the restaurant may be open later, then that restaurant may be demoted down the list of restaurants or alternatively charged a higher rate for presentation to a user if it wishes not to be demoted down the list.

Each time a user enquires about a business, the result of that enquiry can be logged. The data can be compared to predetermined criteria preset, for example, in the registry by the author, and depending upon those choices the system may fetch the data and provide it to the business in order that it can assess the effectiveness of its choices of nodes for hosting information about the business. The fetching of the data may incur a cost, which may be borne by the data supplier or the user, thus the tariff to host the business information may consist of a time based ‘standing charge’, and a ‘pay-per-view’ element reflecting the success of the node in promoting the business. The choice of who bears the cost may be a function of the service level enjoyed by each of the user and the business and the nature of the information that is being requested. Therefore if a user makes an enquiry about a business and the user is located outside of the geographical area in which the business has chosen to post its information, the data can be provided to the business and it has a choice as to whether to make that information available to the user, probably at cost to the business, or whether to restrict the information from the user. Typically network operators will charge a higher amount to the business per viewing of the information than would be the case if the business had contracted with the operator to host that information on that node, so as to encourage businesses to enter into the permanent hosting contracts on the maximum number of nodes, and the business might be offered conditional tariffs such that changeover to a permanent contract could be effected automatically if volumes of user requests merited such change. Alternatively the information may be offered to the user at the user's cost, or might be provided free if the operator was for instance offering such free service as a promotional tool. Furthermore, depending on regulatory conditions and users' sensitivity about exchange of information rating to them, the business may be provided with information about the user making the request. The information may, at one level, be quite general such as merely specifying the gender of the person making the request. However more information may be available about the user, such as their age and interests, and this additional information may be presented to the business, either as part of a service provided by the network operator or as information which may be provided to the business at cost.

‘Data Mining’, a term referring to the extraction from data sets which record such user interests of information useful to advertisers and retailers, can be enhanced by facilities in these nodes. User access to information can be recorded down to very precise levels. This metering of activity can be passed back via the managing servers to various bodies, or used locally on the node. For instance users could ask a node which is the most popular restaurant in the locality, and could qualify that request by specifying a particular style or cuisine. A node could maintain its ‘top ten’ in many categories. Users could add their own electronic testimonials concerning business, which were promoted on the node. Statistics of usage could be supplied to advertisers, advertising audit organizations, the node operators, advertising and content regulators, and the node itself could have an effectiveness ranking. This list is not exhaustive.

Some more national businesses, such as retailers or renters of music and film may also choose to host data within one or more nodes within a cluster. These businesses may then allow users to view, either on a pay-per-view basis, or to download for permanent ownership, the latest releases of music of video or other forms of media content. It is estimated that, in the US, 90% of rental income for movies comes only from the ten most recent blockbuster movies. Other countries may be expected to show similar patterns. It is feasible and cost effective, even at the prices prevailing early in 2005, to install sufficient flash memory in each node for it to hold two movies at DVD quality. This requires about 8 to 9 Gb (gigabytes) of storage. It will also be apparent that different nodes in a cluster can hold different movies such that even a small cluster comprising only five nodes could hold ten of the most recent or popular movies. Thus the present invention could allow a movie rental business to avoid the costs and overheads associated with obtaining multiple copies of a movie for physical distribution and could instead allow it to stream or sell unlimited copies of movies as of the first day of its release. The present invention allows those selling or renting copyright media content opportunities which are difficult or impossible with current technology: for instance there is a current convention that feature movies are shown first in cinemas or movie-theatres, and then progress via video and DVD releases for sale thence finally to the rental market. Using this invention a business involved with the renting or distribution of movies or music could operate a dynamic charging policy, whereby movies viewed within the first few days of their release could be charged at a premium, or could charge for pre-releases, or release ahead of the current convention, generating a new market in which the cost of viewing would be related to more to the newness of the material and less directly related to the medium of storage or viewing.

Such a scheme also provides for enhanced copyright protection since, given that no physical copies of the movie or music need to be made, each electronic copy could have a unique identity code or license associated with it controlling the rights and permissions associated with that copy.

A co-pending patent application commonly assigned to Last Mile Communications/TIVIS Limited describes a security system using tables of random bytes which can be interpreted either as long numbers (so long that the chances of guessing a specific one are practically zero) or as encoding bytes for securely encoding communications, wherein the bytes are generated as key pairs for very secure mutual authentication. An individual's numbers are contained in a hardware device, which may be referred to as a key device. Such a security scheme may be used in conjunction with the nodes of the present invention to ensure that media downloaded over the communication system is associated with a key. More preferably, when a user wishes to acquire protected media content (such as a film or music), then the system reads a public part of the user's data and transmits this (preferably in a secure channel) over the communications network to a bank or trusted service provider with whom the user has registered to enable the user to use their shared secrets as a way identify themselves and a way to pay for their transactions. The user may then browse titles offered by participating vendors. Supposing that the user chooses to buy a media item, the vendor or a remote service provider who is authorized by the copyright holder to make the sale contacts the bank's computer and completes the sale, preferably by the exchange of long number authorization codes. The vendor then exchanges an authentication with the user, again preferably using long number authorization codes and encoded communication of messages, marking a remote copy of the user's account with the fact that this purchase has occurred. For security the vendor may also contact the bank to validate that this transaction has occurred. Copies of all of these transactions are transferred into a secure memory. The secure memory may be in the key device described above, or another device.

By means of this secure purchase the user may buy a conventional media copy for instance a DVD or CD, or may choose to buy a “virtual” copy of the media held remotely on the vendor's or service provider's computer, together with an authenticated entry in his/her personal electronic storage and key device. The user may be enabled to play this media through any device, which can interface with his key device. This can be on an unlimited play basis, or some other charging model where the cost per play may vary, and the copyright owner or vendor may allow outright purchase after a number of ‘rental’ plays, as an alternative sales mode. The user has the advantage that they can build up a large media library without incurring the penalty of actually having to store the data, and, if using progressive payment, of enjoying the material without incurring the full purchase cost ‘up-front’. This of course means that copyright theft is limited because the user need not actually ever be in possession of a digital media file. However, in alternative models of operation, the key device and the media player may be combined or connectable such that media may be downloaded to a user's player, but this can only be accessed using the correct codes which have been downloaded with the media and which must be matched with a corresponding code in the key device to enable replay.

As a further alternative time limited rental of the media, for example through streaming of the data, may be used to provide user access whilst limiting the chances of copyright theft. The key device may be provided with the capability to interrogate the devices in a replay network with a view to disabling media replay if a device is attached which has the capability of making a copy of the media, although there is often a risk that copying may be achieved using an analogue recording device.

Such copyright theft by copying after decode can be avoided if the point of connection of the key device to the replay equipment, and thus of decode of content that has been encoded by a ‘long number’ or another encryption technique, is electronically very close, and very closely integrated with the means of replay, such that there are no user accessible data streams in conventional or open formats. For instance, the replay of visual images over flat panel displays requires that the information for each ‘pixel’ of the display has to be encoded into row and line drives: putting the point of combination of the key device and decoding circuitry onto the same circuit board as the row and column drive circuitry removes any practical opportunity for the interception of a conventional video signal that could be recorded. Similarly it is now understood in audio enthusiast circles that the cables carrying analogue audio signals to conventional speakers are a limiting factor in the eventual audio quality. Thus ‘active’ speaker systems are now common where the power amplifiers are now integrated into the audio speaker cabinets. In a further trend, many audio power amplifiers now work on the ‘one-bit’ or switching principle in which an electrical drive presents either a positive or a negative voltage, with minimized switching time between the two states, and switching at a significantly higher frequency than the highest audio frequency to be rendered, such that this signal can be fed through a passive low pass filter to the speaker drive point, with the audio voltage waveform rendered faithfully after the filter. Such drives, closely integrated with the speaker, are ideal points for implementation of decode with the key device, and would render it very difficult for a member of the general public to obtain a good analogue audio signal to record. Where program material was in a conventional audio-visual form, with one visual data stream, and one or more audio streams, then there could be one point of connection of the user's key device, for instance on the visual display device, and separate digital data streams could be passed by conventional means (wired or wireless or infra-red) to the audio speakers, to enable the decode of those data streams.

As with all equipment that seeks to prevent copyright theft of recorded media, the individual who wished to make unlicensed copies might not identify their interests with such prevention means, however if the recording and media industries had such techniques then sale of media at a cheaper price when in such protected form should produce market pressures such that the equipment manufacturers would adopt the protective techniques.

It is expected that, in order to provide high reliability, nodes may be provided at frequent intervals. They may, for example, be positioned at each streetlight or every other street light or other item of roadside furniture in a housing development or along a roadside. This gives the capability of the devices forming a mesh or cross-linked grid where each user could potentially be served by two or even more nodes providing redundancy against failure of a node, or temporary degradation of performance of the node. Note here a distinction which corresponds to emerging usage of terms: a mesh generally implies that the same wireless communication means or standard is used to communicate between nodes as is used to communicate from a node to a user with a wireless enabled device such as a PDA, laptop or phone. Use of the same standard degrades the total bandwidth for either activity. By contrast a cross-linked grid will use a different frequency or band or modulation for the linking between the nodes than is used to link to users, and this gives full bandwidth to a user group served by a node. Further, the cross links have a fixed direction, and so directional antennas may be used to increase the antenna gain in the direction of the next node. On the one hand this allows either a decrease in transmission power, or an increase in data rate for the same power, or a combination of both. On the other hand, and more importantly, if the transmission beams are made very narrow, then mutual interference between the various links between nodes is minimized, and the licensed bandwidth can be used more effectively by re-use of sub-bands or channels of that licensed bandwidth at closer geographic distances. Narrow beams are obtained by use of antennas with dimensions of many wavelengths: use of high frequencies allows such high gain directional antennas to be physically small. At 60 GHz the wavelength is approximately 5 mm and a narrow beam of about 5 degrees can be formed with antennas with dimensions of about 100 mm.

Such a dense covering of nodes provides the possibility of implementing automated neighborhood security. Thus, each node may be provided with one or more sensors, such as microphones and/or one or more video cameras. This list is non-exhaustive and other sensor devices may be included such as ionizing radiation detectors, detectors responsive to specific chemicals or biological agents, accelerometers and seismometers and other environmental monitoring devices. A data processor may record the output of the microphones and video cameras, or such sensors as are provided, in order to provide a recent log, for example spanning the most recent 24 hours, of a events occurring adjacent the node such that this information may be available to authorities in the event that a crime has been committed. This data is normally kept locked away from access, but may be released upon provision of a security code for inspection by suitably authorized individuals or authorities, such as the police or homeland security agencies. Furthermore, the data processor may analyze, in real time or near real time, the output from the microphone or camera in order to search for significant events, which may require automatic notification to a human operator for further investigation. Thus the data processor could run algorithms searching, for example, for gunshots, the sound of vehicle crashes, or screams for help and, if it locates a suitable candidate event, could automatically contact a central node whereby an operator could review the most recent audio or video recordings, or view the environment live, in order to assess whether assistance is required. Additionally this processor might be enabled to trigger additional local sensors to come live or to an enhanced state, such as causing CCTV monitors to run continuously or at high definition or full frame rate, so that for a period of time after that trigger event recorded data was of an enhanced quality. Similarly, the camera could provide images for traffic flow or crowd control purposes to a surveillance node, and its output could also automatically be monitored to, for example, detect the presence of a fire or a crash in the vicinity such that the emergency services could be automatically alerted.

This describes how the nodes can host and provide power and connectivity for sensors to detect and assess emergency situations. Additionally they can be used to disseminate public warnings of disasters, and of what the public should do. Warnings of floods, earthquake, extreme weather, tidal wave, fires and so on can be disseminated both wirelessly to the normal client base of connected PDAs and mobile phones, but also by attached visual displays and audio means. Interaction is also possible with the emergency services, for instance providing high bandwidth connectivity to stream CCTV generated from portable cameras back to an emergency control centre, or to telemeter medical data on a patient being treated locally to the node back to a hospital or medical emergency centre for more expert assessment. Emergency control personnel such as the police might also have access to the node to load particular warning material pertinent to that location for dissemination via the above-mentioned means.

Preferably the communication from one node to another node within a cluster is via wireless communications. Thus a node may have direct wireless communication with its nearest neighbors. The node may have indirect communication with more remote nodes within a cluster by using one or more intermediate nodes to act as relay nodes. This forms the “sea of connectivity” described hereinbefore.

Where dwellings are provided with fixed user devices, which are always on, then it is possible for these to be used as relay nodes as well. This further enhances the provision of multiple data routes for the provision of data transfer. Where, for security reasons dwellings have been provided with a fixed directional antenna, the antenna may need upgrading to facilitate direction switching, or multiple antennas may be provided.

The user devices may be static devices provided in a user's home, in order to provide the equivalent of fixed telephone and television connections. Additionally or alternatively, the user devices may be portable. Therefore a user can obtain information about their environment as they pass by one or more nodes of a cluster. The portable user device advantageously includes local processing such that it can cooperate with the local nodes in order to present information to the user. Advantageously a graphical user interface is supported such that map data from the cluster can be provided to the portable user device in order to present a map representing significant features of the locality to the user, together with a representation of the user's position. Those features which are represented may be searchable by the user. Therefore, if for example a user wishes to search for local hotels, then the map may display hotels and guest houses matching the search criteria defined by the user and limited implicitly to those businesses which are local to the node (although “local” may encompass a radius of several kilometers), or explicitly by a geographical region that the user has selected. The selection of a region is preferably made by pointing to a region of a map displayed on the display of the user's device.

Advantageously the map may be presented in a three dimensional form, for example using techniques borrowed from the computer aided design or computer gaming worlds in order to present a virtual representation of the street. Representations of those businesses which the user has expressed an interest in may be highlighted, either by use of a different level of intensity, a marker, the use of flashing, or by providing a high definition or enhanced representation of the building in which the business is located whereas surrounding buildings are presented in reduced definition or an outline form only.

Where the three dimensional representation is used, the general topography and outlines of the buildings can be taken directly from the contours and building outline data of established map sets from national authorities or others, for instance in the UK from the Ordnance survey data. Advantageously, the registry entry for the database held in the cache memory of the node allows an information author to supply data, such as a reference to a three dimensional model or even the model itself, pertaining to a building or area of interest. The display application of a user's device can then render this data so that, for example, a shop or hotel can be viewed as a simulated virtual reality model. The modeling need not be restricted to the external view of the building. A combined model of the exterior and interior of a building can be particularly useful, and may for example simulate the arrival of a passenger at an airport terminal and their passage from the correct entrance to their check-in area. A similar facility might also be useful in hospitals to enable patients and visitors to find the correct department. Such visualization data also has value to the emergency services: for instance in the event of a fire or evacuation, emergency response crews arriving on the scene would be able to visualize the interior of the building, and, for instance, seek alternate evacuation exits.

In local or regional emergencies, a further aspect of the invention is advantageous. Each element of the data in the registry can have a value included which determines its priority or importance, or that of a particular service that the data controls or enables, in times of emergency. An authorized agency, for instance FEMA in the USA, a police or fire and rescue service, can instruct the network that a certain level of emergency is now declared, and content that has a priority less than this is simply made passive in memory. Such instructions can be for a whole area of a network, or different for individual nodes in a network. This will have the effect of allowing the transactional load on the network to be reduced or controlled, and if the network is equipped with back-up power supplies, for instance battery backup, this will enable the network to run for a longer time on the available backup supply. For example the emergency level might be coded 0 to 9, with 0 being no emergency, and 9 being the most severe. If brand adverts for products were given a priority of 1, then they will be available to users when the emergency level is set to zero or 1, but would be rendered passive by an emergency declaration of level 2. Emergency information messages from the authorities might be encoded 10, meaning that they can never be blocked. An example of data, which might have an intermediate value, might be first aid information or courses, or mapping data of an area, which would remain useful in an emergency, but might still be turned off if power constraints were severe. Since the data in the registry is either content which can include messages, or blocks of data which control the services and hardware aspects of the operation of the node, such a coding scheme allows progressive shutdown of the non-emergency aspects of the node network, turning the full capacity over to the emergency control authorities. This facility is in contrast to the existing cell phone networks, which would be intrinsically useful in an emergency, but which have had to be completely shutdown during terrorist attacks because there is no such progressive and discriminatory mechanism. Use of high priority codes can be assured to legitimate emergency authorities by other aspects of the design of the system.

Data pertaining to an area need not be limited to fixed installations. Temporary events such as sports or music events or traveling events such as fairs and county shows can also use the present invention. The nodes might well be leased from the network operator and authenticated as mobile devices. Such “mobile” nodes may be equipped with positioning devices, such as GPS receivers, or may simply interface with the mobile telephone infrastructure to have that infrastructure perform a positional fix for the node. Each “mobile” node may then authenticate with a controlling server that has a list of acceptable locations for that node pre-loaded, and if the node is in an approved location then the node can be enabled to offer its full range of services. If however the node is not in the correct area or it cannot establish a communication link back to its server, then it may enter a security procedure based on the assumption that it has been stolen. Unlocking the node may then require a secure release code to be sent to it next time it can establish communication with the network, or may even require the connection of a secure key to the node.

“Mobile” units such as those described above might also be used by a number of business whose operations involve changing locations such as real estate agents (realtors), builders, highways contractors and so on. In the example of real estate agents or builders they could place these mobile devices outside buildings that they were selling, offering a great deal of detail to those equipped with a PDA or other device, including virtual reality tours and high definition digital images, without having to have an agent present in person, or to make appointments with such agents. Such business might chose to allow third party content onto these “mobile” nodes, in which case they have all the functionality of a normal node with the equivalent up-link capability. Additionally such mobile units might be used as charging entry points or toll station at events such as horse race meetings or county shows, issuing electronic entry tickets wirelessly to users with a device such as a PDA and a chargeable account with which to effect payment.

Other users might choose versions of nodes having reduced functionality, for example much smaller caches and/or modified communication capability. Such modified nodes may be programmed with data pertaining solely to the goods and services offered by that business, e.g. the properties of a realtor, and the communications capability may be modified such that the device will only uphold voice or video calls to that business. Internet traffic may be similarly restricted to inhibit visits to the sites of competing organizations.

The level of service presented to a user may depend upon their preferences and/or the amount of money, which they are prepared to pay. Thus, for example, a minimal level of service may only present to a user, information which has been posted by advertisers and/or local authorities. A higher and hence more expensive service level may include the option to use the bi-directional telecommunications capability between the user device and the nodes in order to provide for telecommunications and Internet style services. Further features, such as the use of the mapping and search facilities may also be dependent upon the service level that a user is prepared to pay for.

Advantageously wireless communications from one node to another is performed using a microwave link. Microwave transmit power may be limited in order to reduce the range of each node thereby reducing the potential for overlap. Alternatively, the frequency chosen for the transmission may be selected so as to limit the transmission range. A transmission frequency around 65 GHz exhibits such properties as this corresponds to the oxygen absorption band.

According to a second aspect of the present invention, there is provided a surveillance system comprising a plurality of nodes having sensors for surveying the environment, the nodes further comprising wireless communication devices for establishing communication between the nodes, and the nodes arranged into groups with one node within the group having connection to a further telecommunications network such that a node can send data via the telecommunications network.

According to a third aspect of the present invention there is provided a media delivery system comprising a plurality of nodes having memory for storing media content, and the nodes can deliver the media content in a copy protected format wirelessly to suitably enabled user devices.

A content provider may speculatively load content in to the memory of a node, such that it is readily available in case a user wishes to access the content. Viewing patterns for a large population tend to be relatively predictable and the latest blockbuster movie releases would tend to be most wanted, and hence would be suitable candidates for speculative uploading into the memory.

A fourth aspect of the invention provides a distributed communications network comprising a plurality of nodes and a plurality of user devices, wherein each node comprises: a communications device for establishing bi-directional wireless communication with at least one user device; a communications device for establishing bi-directional communication with at least one other node; and a data processor in association with a local memory for storing information for presentation to users, and wherein the information is held in the local memory in a searchable form.

A fifth aspect of the invention provides a distributed communications network comprising a plurality of nodes and a plurality of user devices, wherein each node comprises: a communications device for establishing bi-directional wireless communication with at least one user device; a communications device for establishing bi-directional communication with at least one other node; and a data processor in association with a local memory for storing information for presentation to users, wherein the information includes data enabling a map to be presented on a user device in three-dimensional form.

A sixth aspect of the invention provides a distributed communications network comprising a plurality of nodes and a plurality of user devices, wherein each node comprises: a communications device for establishing bi-directional wireless communication with at least one user device and a data processor in association with a local memory for storing information for presentation to users, wherein the information includes time data, and wherein the data processor is programmed to deliver information to a user which varies in accordance with the time data. The node may be further provisioned with a communications device for establishing bi-directional communication with at least one other node, or may be stand-alone with a back haul connection (e.g., DSL, cable, optical fiber, etc.) to the Internet. Various embodiments of the sixth aspect of the invention are described herein with reference to a “difference engine”.

The present invention will further be described, by way of example, with reference to the accompanying drawings, in which:

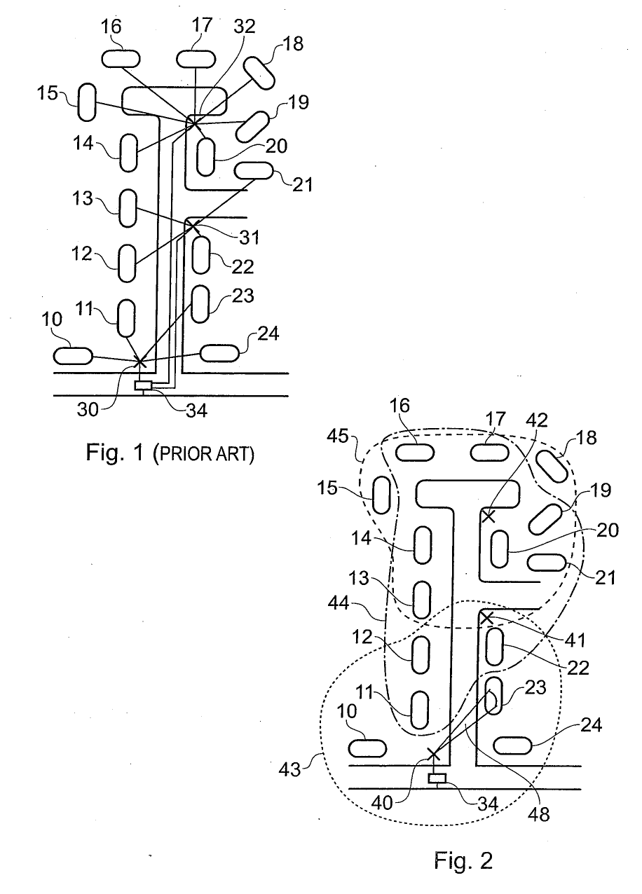

FIG. 1 schematically illustrates the cable paths required to connect a group of dwellings to a POTS telephone network of the prior art;

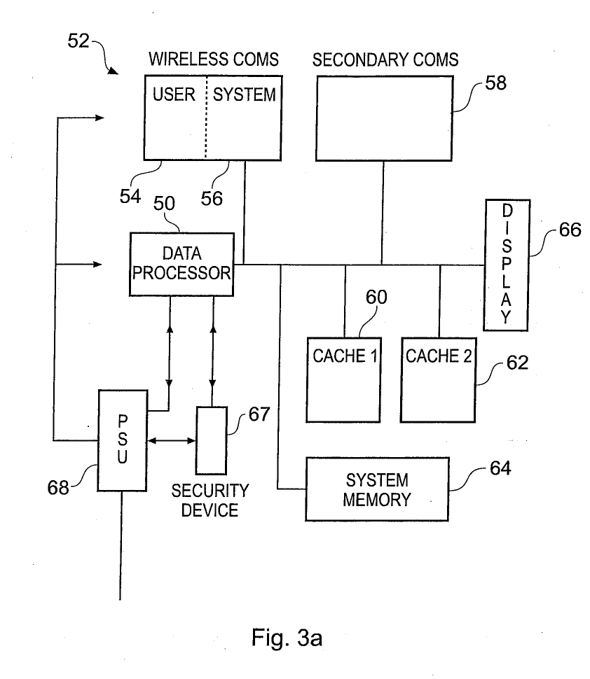

FIG. 2 schematically illustrates one way in which the group of dwellings could have telephone and data services provided using a communications network constituting an embodiment of the present invention;

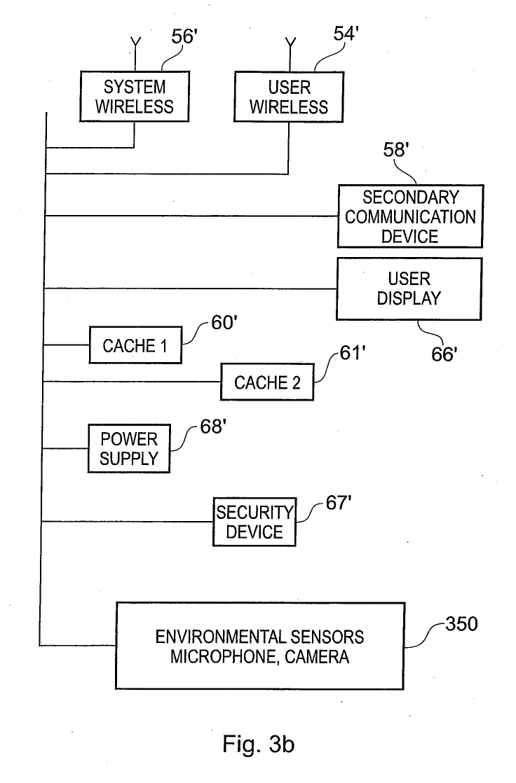

FIG. 3a schematically illustrates the components within a node constituting an embodiment of the present invention;

FIG. 3b illustrates an alternative node construction;

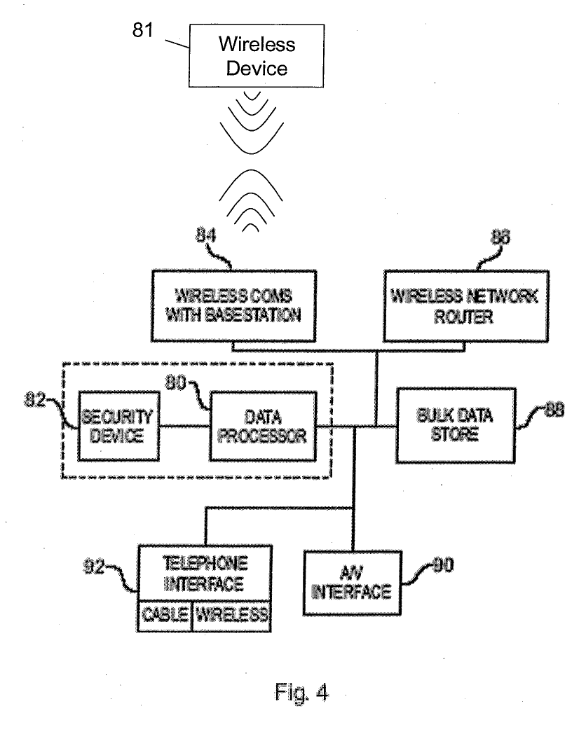

FIG. 4 schematically illustrates a user device;

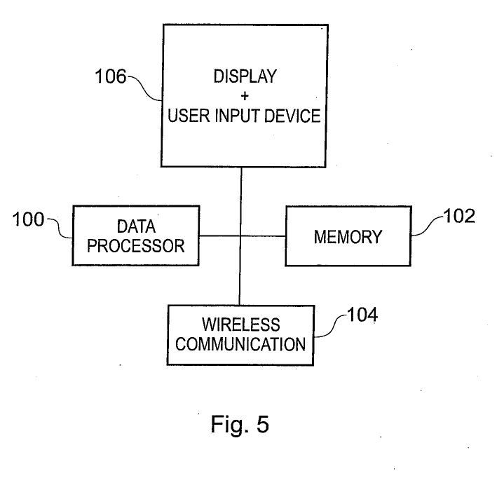

FIG. 5 schematically illustrates a portable user device;

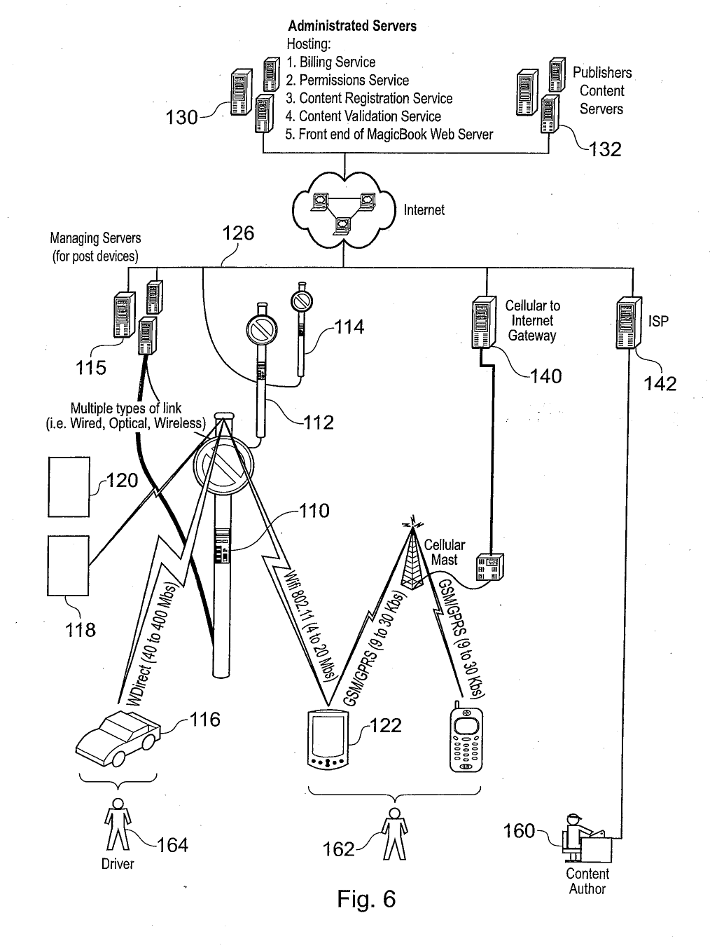

FIG. 6 schematically illustrates the connectivity between various system components and a telecommunications network;

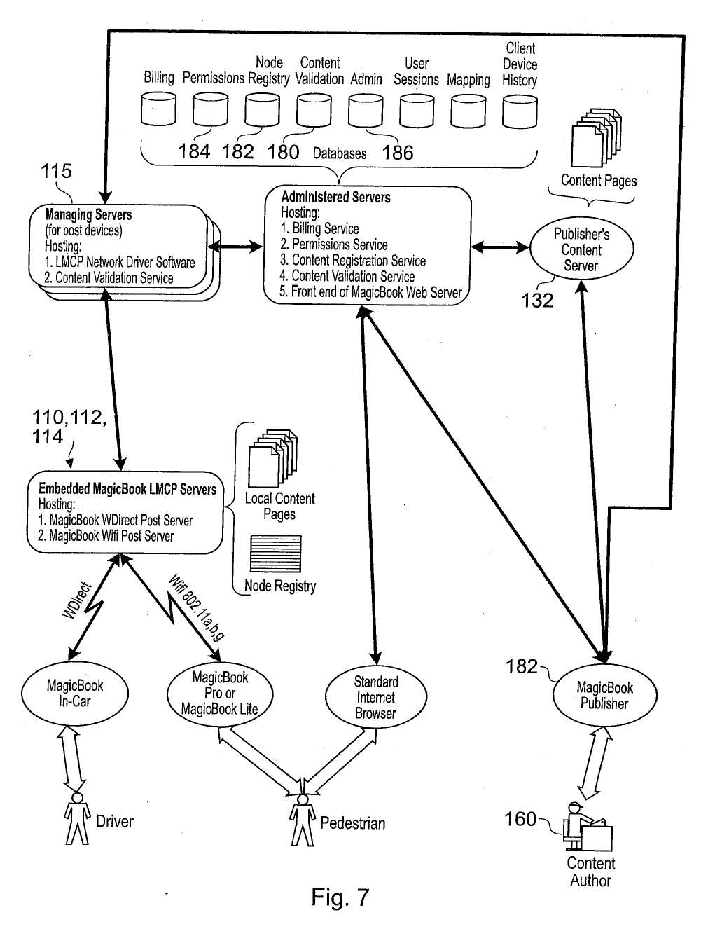

FIG. 7 schematically illustrates component inter-operability with a system constituting an embodiment of the present invention;

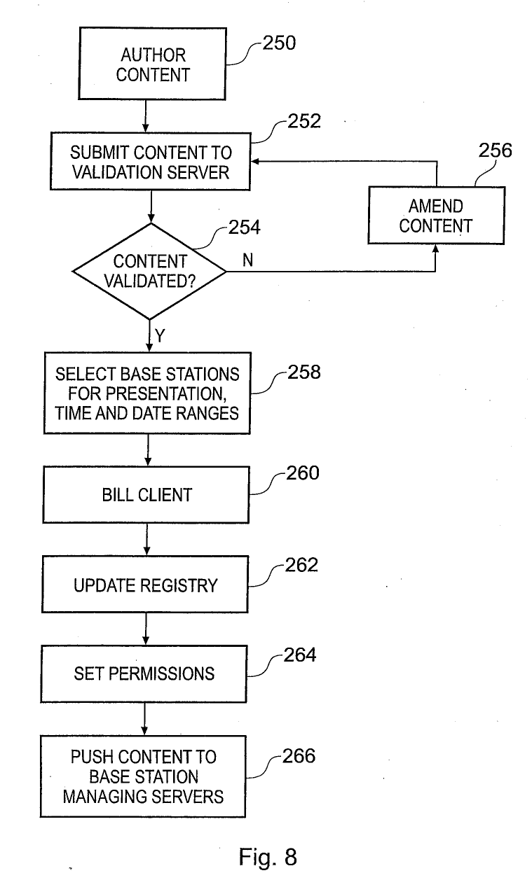

FIG. 8 illustrates the process of validating content and sending it to node;

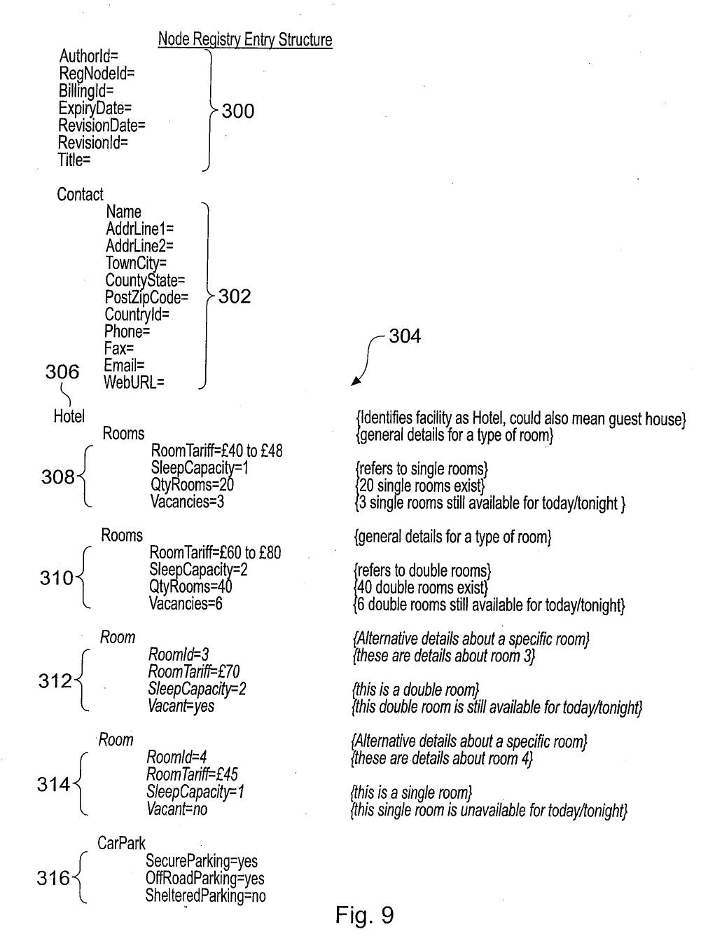

FIG. 9 illustrates an entry in a registry held in a node;

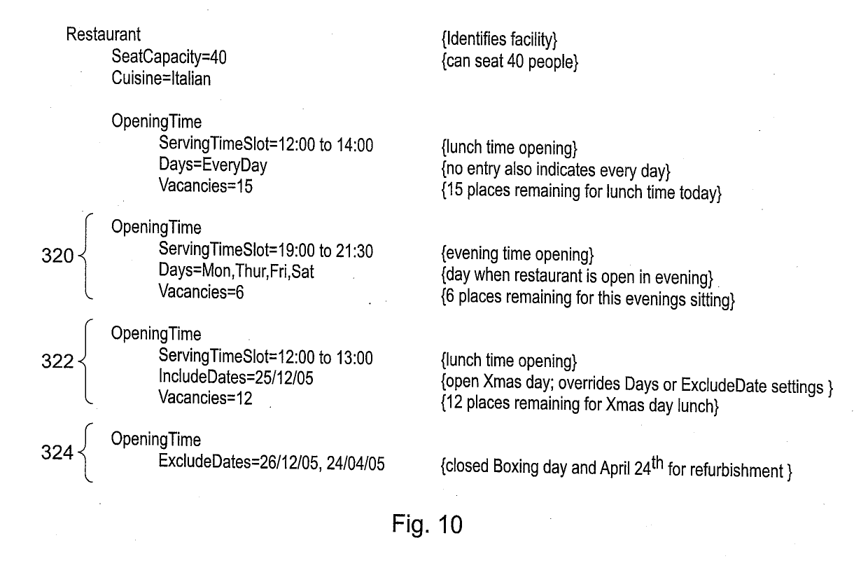

FIG. 10 shows a further example of a registry entry; and

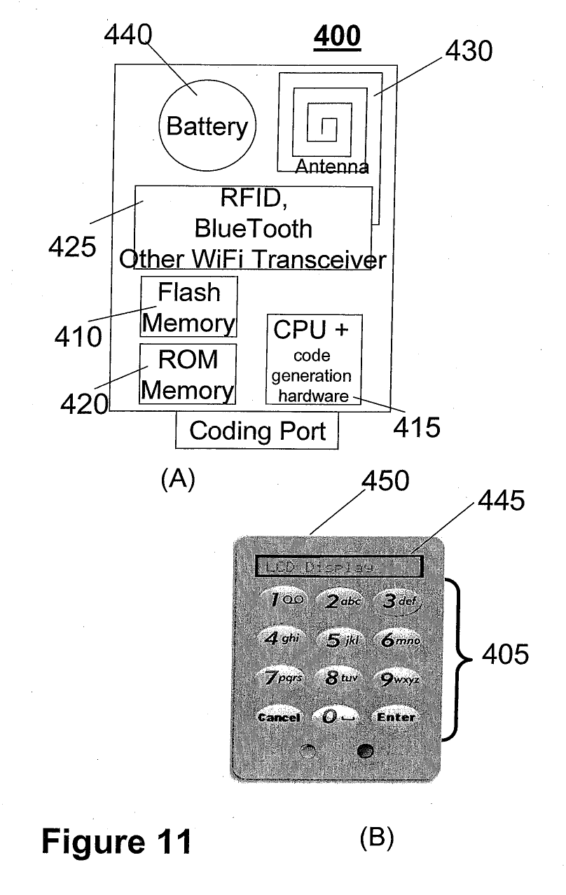

FIGS. 11A and 11B depict a smart card for use in conducting commerce transactions within said communications network of the invention.

FIG. 1 schematically illustrates an arrangement of houses 10 to 24 arranged along a street. In this prior art arrangement each house is served by a telephone cable, which runs to the house from one of the telephone poles labeled 30, 31 and 32. There are practical limits on the length of cable, which should run between a house and a telephone pole and consequently the poles only serve a relatively small number of physically close houses. Thus, in this example, telephone pole 30 has connections running from it to houses 10, 11, 23 and 24. Telephone pole 31 only has connections to houses 12, 13, 21 and 22. Finally telephone pole 32 has connections to houses 14 to 20. Each pole is typically connected by subterranean wiring to an access point 34 which in turn is connected by subterranean cabling to other components within the telephone infrastructure, such as local exchanges and ultimately the data carrying backbone, such as fiber optic links, which represent the trunk routes within the telephone infrastructure. The use of subterranean wiring is often not a preferred technical solution, but may be imposed upon operators by local authorities who may be keen to avoid the visual impact of over head wires and poles.

It is known that laying underground cables is relatively expensive and, as of 2005 it is estimated that the cost of placing an underground cable is in the region of $200 per meter. It can be seen from FIG. 1 that, even if multiple cables run along a single conduit a significant amount of trenching still needs to be done between the access point 34 and telephone pole 32 in order to serve a relatively small number of customers.

A communications device constituting an embodiment of the present invention, enables the conventional telephone cabling to be replaced with short range and secure wireless links. This is illustrated in FIG. 2 where the same housing layout is serviced by communication devices constituting embodiments of the present invention. In one embodiment of the device, microwave communication is used for point to point transmission and it is therefore reasonable to assume that data communication is effectively restricted to a line of sight travel. However, alternate embodiments make use of communications devices or other digital devices adapted for “near” line-of-sight wireless communications, e.g., outside of the KU frequency band in a 20 GHz range band. Furthermore, multiple re-use of electromagnetic spectrum frequency space can be achieved by limiting the transmission range of each device, at least in built up areas, to several hundred meters. Of course, this does not preclude use of longer transmission ranges where appropriate either by increasing the transmit power or by using antenna systems exhibiting higher directional gain.

In the arrangement shown in FIG. 2, nodes constituting embodiments of the present invention have been placed in the positions that would have been occupied by telephone poles. Thus a first node, labeled 40 occupies the same position as telephone pole 30. A second node labeled 41 occupies the position of telephone pole 31 of FIG. 1 and a node 42 occupies the same position as the telephone pole 32 in FIG. 1. Each node is assumed to be able to establish line of sight contact with the houses 10 to 24 which it can see directly, but houses, which are partially obscured by another house or houses which are distant from the node are not assumed to be able to establish contact. Thus, in this scenario, the first node 40 can establish contact with houses 10, 11, 12, 22, 23, 24 and the node 41. It is also feasible; depending on transmit power and aerial gain, that the first node 40 might also be able to establish contact with houses 20, 17 and the third node 42. The first node 40 is also in communication with the telephone system via the access point 34 or by being cabled to the local exchange or trunk network.

The second node 41 can establish communication with houses 11, 12, 13, 14, 16, 17, 19, 20, 21 and also has communication with both nodes 40 and 42. The third node 42 can establish communication with houses 13, 14, 15, 16, 17, 18, 19, 20 and 21 and depending on signal strength may also be able to be able to establish communication with houses 12, 11 and 22. As noted before the node 42 is definitely in communication with node 41 and may be able to establish communication with node 40.

It is understood that such communications between the first nodes, second node and third nodes, or between nodes and the telephone system, are enabled by provision of a wireless communications network infrastructure including devices adapted for communications outside of the KU frequency band, such as, for example, between about 20 GHz to about 75 GHz. It is particularly advantageous to enable wireless communications between nodes in the 20 GHz range band. Additionally, it is particularly advantageous to enable wireless connectivity between nodes and the user devices (computers, digital devices (e.g., PDAs)) whether at a places of residence or business, and mobile telephone devices), utilizing standard wireless access protocols (e.g., Bluetooth, IrDA, etc.). It is further understood that the node is adapted for receiving a third party installation (i.e., from a user, business or other entity) comprising, for example, an optical fiber connection, a satellite dish, or other communications device for connection to a further communications network or another node.

Moreover, optical fiber connectivity may be provided between the first nodes, second node and third nodes, and between nodes and a backbone network. Such optical fiber communications network infrastructure enables communication data rates of up to 300 GBits/sec or greater. Preferably, a nodes is architected with functionality to receive, extract and store data at Terabit/sec data rates as transmitted via optical fibers. Particularly, useful is the adaptability of the node to receive a third party fiber optic installation (i.e., from a user, business or other entity) delivering high speed transmission of data to others via the node, for instance, utilizing the emerging wavelength division multiplexing (WDM) scheme.

In a further embodiment, it is understood that mobile devices may be equipped with mobile electronic communications capability for receiving and transmitting near line-of-sight (LOS) communications (e.g., about 20 GHz range) or more LOS 63-75 GHz range). This is particularly useful for nodes at more sparsely populated areas, e.g., in area of mountainous or desert topologies where distances between neighboring towns is great and high capacity communications infrastructures are limited and or non-existent. In such a scenario, it would be advantageous to enable a node to download its payload, i.e., data content, to a mobile vehicle that is passing by, e.g., a car, equipped with memory capacity and communications infrastructure to receive high frequency data signals, e.g., in the 63-75 GHz range, temporarily cache the downloaded data content, physically move the cached information to different locales and, be synchronized to upload the data content back to another node it passes downstream, e.g., at a locale down the road. Thus, the mobile vehicle, in essence, provides a data replication or uplink function as it may be programmed to store, physically re-locate the data payload and, re-synchronize transmission of the data payload to another remotely located node, a process herein referred to as “Tire net”.

In still yet a further embodiment, it is understood that hand-held devices, assuming greater processor speeds and processing power capabilities may be equipped for receiving and transmitting communications via standard wireless (e.g., WiFi, Bluetooth, IrDa) communications protocols. Thus, the user hand-held device, e.g., a PDA or like pervasive digital device may provide the data replication or uplink function as it may be programmed to store, physically re-locate a data payload and, synchronize transmission of the data payload to another remotely located node.

It is understood that each of the communications modalities described herein provide security, e.g., by way of applying data either encoding and encryption technologies, or both. Thus, with respect to the uplink function, only a node that can understand the encoding and encryption method applied may synchronize with the data synchronized uplink device. Current mesh network designs implement similar technologies that are adaptable for use in this context.

As illustrated in FIG. 2, the limit of connectivity around each node is represented by the chain lines 43, 44 and 45 for the nodes 40, 41 and 42 respectively where the nodes are engaging in omni-directional transmission and reception, as might be the case using WiFi. However, the nodes may also support switchable directional antennas to enable transmit and receive beam steering. In which case the range at which connectivity may be established may be increased due to the antenna gain. The transmit/receive beam width would of course be much narrower and current directional antenna technology for use with 65 GHz or greater, e.g. 75 GHz, microwave communication systems enables beam widths of around 10 degrees to be formed to rapidly in order to form a time division multiplexed service to the individual houses. The node to node communication may also be performed using steerable antennas, but in general is established using more conventional dished antennas (say 200 mm diameter or so) to provide permanent directional capability form one node to the next. Any given node may have several such fixed antennas installed to enable it to communicate with its neighboring nodes. A directional transmit beam is schematically illustrated as beam 48 between the node 40 and house 23. Increased functionality is additionally provided by equipping the nodes with ability to communicate with other nodes and homes, business and residences and user devices at much lower frequencies, i.e., wireless communications outside of the line-of-sight or “near” line-of-sight frequencies, e.g., outside KU frequency band.

Comparing the arrangement shown in FIG. 1 and FIG. 2, it can be seen that the amount of underground cabling to service the houses 10 to 24 has been significantly reduced compared to that shown in FIG. 1. However, in each scenario the houses can still enjoy at least the same telecommunications standards although it is expected that the houses using the communication system constituting an embodiment of the invention will actually receive an improved telecommunication service for reasons that will be described hereinafter.

Supposing, with reference to FIG. 2, that the occupants of house 17 wish to make a telephone call or access the Internet. Their telephone or computer (if using voice over IP) will establish communication via a user device located within the house with the node 42. Node 42 will then co-operate with node 41 and node 40 such that a relay chain is formed from node 40, to node 41, then to node 42, and then to the house 17 such that communications can be established between the house 17 and the telecommunications network. However, in situations where the node 42 can communicate directly with the node 40, then a direct link between these nodes may be formed.

Although the arrangements shown in FIGS. 1 and 2 relate to only a single road running off a main road, housing estates are generally more densely populated and hence similar groups of houses might be expected to be positioned quite close to the one illustrated in FIGS. 1 and 2. This gives rise to the possibility that nodes 41 and 42 may be able to see other nodes which themselves can see further nodes some of which are connected to the telephone/data network infrastructure access node. This is advantageous since it means, for example, that node 42 might still be able to establish a link with the telephone infrastructure via these other nodes even if a fault were to develop on node 40. This provides redundancy against system failure and also provides enhanced reliability against the possibility of a device becoming “busy” due to a transitory high workload.

FIG. 3a schematically illustrates the components within an embodiment of a node. The node comprises a data processor, which controls the functionality provided by the node. The data processor is in communication with a wireless communication device 52 which provides bi-directional communication. The wireless communications device 52 may comprise one or more wireless systems having a network infrastructure adapted for communicating at frequencies of 20 GHz or greater, up to 75 GHz. Furthermore, although the wireless communication device 52 may only comprise one device: it nevertheless logically provides user communication and system communication and these separate functions have been designated 54 and 56, respectively. The data processor 50 further has access to a secondary communication device 58, which may be a wireless communication device, a cable operated communications device or a combination of both. The secondary communication device 58 may comprise devices adapted for receiving and decoding wavelength division multiplexed signals transmitted via optical fibers. Thus, in additional embodiments, a high capacity optic fiber infrastructure may be provided to enable communications between nodes and other nodes and/or between nodes and the user, home or business. Current optical communications systems have demonstrated communication capacity in the Terabit range, and certainly accommodate communication data rates up to 300 GBits/sec or more along existing single mode fiber, e.g., running 140 Km to 160 kilometers in length. Utilizing the emerging WDM standard, the data carrying capacity of single mode fiber is greatly increased. Lower loss transmissions are achievable using newer optical fiber cables optimized for transmission in the portion of the spectrum between 1310 nm and 1620 nm wavelengths and utilizing state of the art laser diodes and photodetectors. However, it is understood that connectivity is not limited to this wavelength range, and multiple fibers may provide I/O and data communications at wavelengths ranging between 1310 nm and about 405 nm.

As further shown in FIG. 3A, the data processor 50 also has access to at least one local cache memory 60 and may have access to a second and indeed further cache memories 62. The cache memory 60 and 62 is, in a preferred embodiment, provided by non-volatile rewritable semiconductor memory. Current FLASH memory devices are routinely available in sizes in excess of 1 Gb and several devices can be used together in order to form a composite cache memory whose size is of the order of several Gb. Memory cost has been falling rapidly whilst, simultaneously, memory size has been increasing rapidly. It is therefore envisaged that large memory sizes will become used routinely as memory technology evolves. The data processor 50 is also in communication with a system memory 64. The system memory 64 holds instructions to be executed by the data processor for providing the desired functionality of the node and may also hold keys or ciphers or other data which may be used to control a user's access to the system, the privileges they enjoy on it, and which also may be used to code or encrypt data flow from a node to a user device or from a node to the telecommunication system or network control system of the present invention. The system memory 64 is itself likely to be implemented in FLASH electrically erasable programmable read only memory (EPROM) such that operators of the node can add new functionality remotely. The data processor 50 may also drive a display device 66 upon which visual messages may be placed. These messages may include, without limitation, warnings, local information, advertisements and the like.

In addition, the data processor 50 has access to a local memory device 69 provided in the node that comprises a non-volatile memory, particularly a memory that is able to retain data storage without external power, for example, by FLASH memory, or, where memory lifetime and speed is important, e.g., SRAM, where a constant voltage source is supplied (e.g., via battery). Where nodes are located indoors or in environmentally suitable locations, hard disks such as Seagate Technology's NL35 Series with long (i.e., greater than 1 million hours) Mean Time Between Failures, or like devices are advantageously employed. In outdoor or environmentally harsh conditions, where temperature cycling and vibration can adversely effect the longevity of such devices (disk drives), solid state memory is preferred as storage size is rapidly increasing whilst cost is decreasing. The local non-volatile memory is preferably used as a cache. High-speed DRAM (e.g., DDR RAM) may be utilized as part of the node architecture.

One embodiment of a local memory device 69 provided at the node as shown in FIG. 3A is the “Shared Storage Plus” hard-disk drive available from Maxtor Inc. (based in Milpitas, Calif.). This drive provides storage of up to 500 Gbyte or more capacity, and implements multi-tasking capacity and functionality for providing content to a plurality of user devices (e.g., home theatre, music player, video game player, etc.) while completely bypassing connectivity to any user's personal computer. Such devices may be implemented at a node located at the home, for storing and delivering data content to users in the home or business location, to users via their wireless devices outside the home via the communications devices described. This current mass storage device technology implements media-management software such as available from Mediabolic, Inc. (San Mateo, Calif.). This software provides devices with functionality in conformance with industry standards (e.g., the Digital Living Network Alliance (DLNA), Universal Plug and Play (UPnP), and Intel Corp.'s Networked Media Product Requirements (NMPR)) that permit many user devices to connect with the hard drive such that it can perform without requiring the central intelligence of a personal computer. Thus firewall-like security is ensured. Moreover, the build-up of such a memory cache close to the user virtually eliminates contention. Advantageously, a host environment provisioned with significant storage such as available from a Maxtor mass storage device, enables the delivery of full catalogues of media content (e.g., movies) to the users, currently unachievable by conventional cable content providers.

Further as shown in FIG. 3A, the data processor is also in communication with a security device 67 whose function is to monitor the node for signs of tampering, theft or subversion and to take appropriate action if it is deemed that any of these events have occurred. Thus, if the security device detects circumstances which suggest that an attempt has been made to steal the node, for example because vibration detectors have detected excess vibration, or internal accelerometers have detected that the device is being transported when such transport has not been authorized, then the security device may refuse to release the system keys to the data processor which enable the data in the caches 60 and 62 or information in the system memory 64 to be decrypted. Alternatively, the security device may instruct that the content of the caches 60 and 62 be erased.

Moreover, use of frequency tuned tools may be used as an authentication process to prevent unauthorized tampering. In this embodiment, an RF chip set is built into the tool and used to communicate random number codes as set forth in applicant's co-pending United States patent application corresponding to European Patent Application No. EP05252250.5 entitled “Method and Device for Communicating Using Random Codes” filed Apr. 11, 2005 [attorney docket P106603EP; 19145]. Thus, prior to making any type of repair or otherwise opening the device housing will require first a tool to communicate a code to the data processor or security device that will verify an authorized user of the tool. If such verification process is not performed prior to the opening, the caches may be rendered useless, e.g., data content erased.

FIG. 3b schematically illustrates an alternative design of node in which a passive back plane is an architectural feature but, more significantly, there is no single processor. Instead, each functional element contains one or more processors and the functional elements co-operate by a set of protocols and messages. It can be seen that there is direct one to one correspondence between each function designated in FIG. 3a and the equivalent function shown in FIG. 3b. Thus the system wireless portion 56 of FIG. 3a is now designated 56′ in FIG. 3b. The architecture shown in FIG. 3b has several advantages. Firstly reduced instruction set Harvard architecture processors or hardware equivalents can be used breaking the tasks down into smaller fixed sub-tasks without the possibility of unauthorized parties hacking into the firmware of the system memory. Furthermore a set of small processors, each doing part of a task, can generally outstrip the overall performance of a single more powerful processor. Performance is further enhanced by the absence of an operating system generally provided in a single processor implementations or by the use of very much smaller operating systems which operate faster and with lower overheads. The tasks in the software and hardware are segmented and consequently a subsystem, which is working can remain unchanged whilst other parts of the system are developed or modified. From a management point of view, the use of multiple subsystems attached to a backplane may also have the advantage of providing hot swappable cards such that maintenance may be performed without talking the system down.

The wireless communications device 52 or 52′ will typically support microwave communication for communicating from one node to another, and also for communicating from a node to suitably enabled wireless user devices. Various modulation schemes may be employed on the microwave communication link. Ideally a universal communications scheme would be adopted such that user devices could roam from one country to another. However national governments are responsible for allocating the frequency spaces and transmission schemes available within their jurisdictions and there remains a possibility that governments might frustrate the adoption of a single frequency and transmission scheme. Well understood and relatively easily implemented transmission schemes include quadrature amplitude modulation, frequency and phase shift keying. It is already well known that quadrature amplitude modulation may be provided with different levels of complexity, depending upon the number of symbols that are supported, and once again it will be envisaged that at least a base line standard would be adopted to facilitate inter-operability between user devices which generally operate in different countries. The communication system 52 also preferably supports other well known transmission standards for establishing local connections to user devices. Thus other transmission standards include the 802.11 variants, such as 802.11A, 8072.11B and 802.11G. Similarly infrared communications and Bluetooth communications may also be supported. The provision of the extra communications standards is particularly advantageous where a cluster, which hitherto has described as being in an “external” environment, such as at the road side, is extended into or provided within an interior space such as a shopping mall or an airport. The nodes may also support the DECT telephone standard, thereby enabling users of domestic wireless telephones to be able to dispense with the DECT node and have the telephones interfaced directly with the node of the communication system constituting an embodiment of the present invention.

The secondary communications devices can, for simplicity, be a replica of the primary communications device and can either be used as a backup system or can be used in conjunction with the primary device in order to increase data rate capacity. The secondary communications device may also handle the interface between the node and a cable network to which it is “tied”. However this functionality could, once again, be provided within the primary communications device 52.

The node shown in FIG. 3a probably has to remain continuously powered, due to the overhead is placing such a conventional architecture into a “sleep” mode. However the node shown in FIG. 3b is expected to have a much quicker wake up time period and consequently can put itself into a sleep state. Such a node can generally power up its wireless communications module every 100 to 200 ms, and broadcast an identity message to see if there is any response from a passing user device, for example in a passing vehicle. If no response is received, then it can power down again. However if it gets a response, then all of the other modules can be woken up under hardware command an its next broadcast cycle may include a broadcast of its registry contents thereby enabling the passing user device to initiate a search for information, it may also broadcast priority data, such as recent road safety and weather announcements, and it may then proceed to broadcast information which, based on historical statistical usage, had been requested from that node together with any commercial messages which are set as high priority or mandatory messages.

If the passing vehicle makes a request for specific data, then the node will search its cache to see if that information is available and if not, will place a request for that information to be received from the telecommunications network and either forwarded to that node, or the next node in the direction of vehicle travel. Once the data exchanges have been completed, the node may re-enter its waiting state.

The nodes may also include environmental sensors 350, as shown in FIG. 3b, for monitoring the environment around each node. The sensors may include cameras and microphones. The output of these devices may be stored in a short term memory, for example holding one or two day's worth of output. This data is normally kept locked away from access, but may be released upon provision of a security code for inspection by suitably authorized individuals or authorities, such as the police or home land security agencies.

FIG. 4 schematically illustrates the components within a static user device, which may, for example, be provided within a user's dwelling or place of work to provide a gateway to a telephone network and to the Internet and optionally to audio visual entertainment, given that the radio, television and Internet technologies are converging.

The user device shown in FIG. 4 comprises a data processor which is in communication or advantageously is bound to a security device 82 such that the integrity of operation of the user device can be assured and such that the user device is protected against subversion, either from a user attempting to access services and facilities to which they are not entitled, or from an external malicious individual trying to access the user's personal data. Such “personal data” may include a user device identity and address such that the user device is uniquely and securely associated with one or more given users. The data processor is in communication, via a data bus, with a wireless communications device 84, which handles the communications interface with the node. The data processor 80 is also in communication with a wireless network router 86, for example compliant with the current 802.11 standard or any successor technologies as may be developed which become established for providing local area short range data communications primarily between computers. The wireless network router 86 may also support the Bluetooth standard or any successor technology thereto. The data processor 80 is also in communication with a bulk data store 88 which may be a magnetic store since it is not envisaged that the static user devices will be subjected to extremes of temperature cycling or vibration. However the bulk data store 88 may also be implemented within FLASH memory. A magnetic store is, at the present time, preferred since these provide higher data storage volumes at less cost compared to FLASH technology. The bulk data store may be used for storing a user's personal data, for example documents that they are working on or music that they listen to, as well as user applications which a user may wish to run on the device, thereby enabling it to act both as communications interface and optionally home computer. The bulk data store 88 may also act as a temporary repository of music or video, which may be recorded by a user. The data processor is also in communications with an audio-visual or other multi-media interface 90, which handles both the input and output of audio and visual content such that the device can function both as a music player and as a television. Furthermore, cooperation between the audio-visual interface 90 and the bulk data store 88 means that the device can also function as a video recorder enabling television or other audio visual content to be recorded for later replay. The data processor 80 is also in communication with a telephone interface 92 which supports both cable connection to a user's telephones and wireless connection, for example via Bluetooth or DECT, to wireless telephones. Thus the static user device may, if all of these subsystems are implemented, provide convergence between a computer, a telephone, and an entertainment system.

As mentioned herein, the bulk data store 88 may further comprises the “Shared Storage Plus” hard-disk drive available from Maxtor Inc. that provides multi-tasking functionality for providing content to a plurality of user devices (e.g., home theatre, music player, video game player, etc.) while completely bypassing connectivity to any one user's personal computer. Such devices may be implemented at a node located at the home, for storing and delivering data content to users in the home or, to users via their wireless devices outside the home via the communications devices described. This current mass storage device technology implements media-management software that is adaptable for receiving commands for initiating the download to a plurality of users at a time.

Provision of memory devices such as the Shared Storage Plus hard-disk drive thus enables a home or residence to function as a host capable of delivering content to other users via the wireless devices (see FIGS. 3A, 3B and 4) in a secure manner. That is, implementing such a device that bypasses connectivity to the PC is ultimately secure as no connectivity is established to a host's PC that may have personal or confidential content. Thus, as a host, the data processor device receives user requests for information and performs steps for authorizing the downloading of content to a user device from the bulk storage. The data processor, via conventional means, provides the ability to conduct a transaction to receive payment from a requesting user, or otherwise authorize that user to receive content via their wireless devices from the bulk storage.

FIG. 5 schematically illustrates the components within a portable user device, which may interface with the communications system constituting an embodiment of the present invention. The portable device includes a data processor 100, which is in communication with a memory 102 which may store both operating instructions for the device and user data. The data processor 100 is also in communication with a wireless communications device 104 and a display and user input device 106. The device 106 may comprise a touch screen such that the user can enter information via the display device, either by touching various portions of it with their finger, in effect pressing soft buttons, or may use a pointing device such as a stylus for entering more complex information. The basic functionality of the user device can, as of 2005, be provided by a personal digital assistant although it should be recognized that with the convergence between PDAs, mobile telephones and portable music players that this term in future may become redundant due to the convergence of these technologies. A user interface for both the portable and static devices may, advantageously, build upon existing browser technology since the interface technology is itself well established and users are familiar with it. This therefore facilitates ready uptake and acceptance of the interface.

FIG. 6 schematically illustrates the way in which the node and user devices according to the present invention can interface with existing telecommunications systems and how an operator of the network according to the present invention can control and administer the content provided or hosted at each of the nodes and can also enable content providers to control and vary their content. A plurality of nodes 110, 112 and 114 are provided. In this example, the nodes are installed within “street furniture” such as road signs or “posts”. Each node is the type described hereinbefore with respect to FIG. 3A or 3B. Considering node 110 more fully, the node can support a high speed data link, in the range of 40 to several hundred Mbs using its microwave link or optical fiber link and this can communicate with suitably enabled user devices in dwellings 118 and 120. The node 110 can also support communication with portable or handheld user devices, such as a personal digital assistant 122 over a WiFi (802.11) data link. Each node 110, 112, 114 is connected to a high capacity data communications network such as the backbone of the telecommunication system, either directly or through a cluster of managing servers for managing the node devices. Both types of connection are schematically illustrated in FIG. 6. Connection via dedicated managing servers 115 has the potential to provide enhanced integrity considering the content hosted on each node in its cache. However direct connection to the telecoms backbone 126, as shown for node 114 provides an alternative route for the node 114 to communicate with its managing servers, and indeed other servers which have a presence on the data network 126. The data network 126 is schematically shown as providing connections to the Internet, itself being an ill-defined cluster of servers on a data network, and via the Internet to administration servers 130 operated by the “owners” of the nodes and content servers 132 owned and operated by those entities, typically businesses, which choose to pay to have their own information published or hosted on the nodes 110, 112 and 114.

For completeness, it can also be seen that the communications network of the present invention need not stand alone and that a portable user device 122 may also, like mobile telephone 124, receive data directly from WAP enabled or other servers 140 using the GSM/GPRS mobile telephone infrastructure, and also using the 3G successor networks in due course.

Moreover, the communications network is equipped with self diagnostics capability. As part of both communications and node diagnostics, the node may “ping” the home office with a discrete message. It may be simply a code that is implanted in either ROM or Flash that gets transmitted periodically, e.g., twice a day, that verifies that connections are still clean and the node is alive. This will aid in determining all links in the daisy-chain as well as backhaul as necessary. It will also become a validation signal that information is not lost due to either random or bias bit error. For example, in one embodiment, test codes of various lengths (e.g., 1024 bits) may be utilized and sent through various parts of the network (high reliability and analog portions) to ensure that raw Bit Errors (e.g., in the analog channels portions) of the network are completely random (i.e., no bias exhibited). If bias towards certain errors is detected (not complete randomness), it may be determined that that portion of the network may not be used in communication of transaction information (e.g., long number codes). It is understood however, that alternate statistical solutions may be utilized for communications on that portion of the network (or that part of the network completely bypassed for that kind of transmission).

The telecommunications backbone 126 also provides the method by which a content publisher, i.e. a business, may design and author the information that they wish to be hosted on a node, and then submit this via the Internet service provider 142 for hosting, subject to checking and authentication as necessary by the administration servers 130 and the host servers as necessary.

It should be noted that those devices capable of establishing an Internet or data connection via the nodes of the present invention may transmit voice using the “voice over IP” technology thereby enabling phone calls to standard telephones to be set up.

It is useful to consider the operation of such a network, both in terms of how potential data providers place information into the network, and how users can search for that information and a criteria which might be invoked within the network or node to determine the order in which information is returned to a user.

When a business wishes to advertise its presence or present other information via a network constituting an embodiment of the present invention, the business's content author 160 designs a series of “pages” that are to be hosted in one or more nodes. This design process is represented as step 250 in FIG. 8. The design of pages is similar, if not identical, to the design of web pages for presentation over the Internet. However, where a content author presenting pages over the Internet can be assured that the device retrieving those pages will be a computer having full screen display capabilities, the same cannot be guaranteed with the present invention. This is because some of the pages may be picked up by mobile users, such as pedestrians 162 using a device such a personal digital assistant 122, whereas other information may be picked up by automotive users 164 using “in-car” versions of the device or, where the PDA 122 can be used via an interface in a car 116, and if the car user is not a passenger then functionality of the PDA 122 or ‘in car’ device may be restricted due to the extra safety considerations that need to be addressed given that it is important that a car driver is not unduly distracted from the task of progressing safely and competently along the highway. For that reason, it is useful for the content author to use, as an option, a publishing tool 182 which facilitates the design of the “web pages” using well understood language, such as XML, and which then presents the pages (step 252) across the backbone 126 to one of the administration server 130 running a content validation database 180. Whilst the administration server 130 cannot validate the factual content of the web page, for example it cannot tell if a price has been incorrectly entered, it nevertheless can validate at step 254 the page layout in order to determine whether that page should be capable of being displayed or reproduced in an understandable form against a range of devices which the content publisher has indicated as being target devices for their content. The content validation database within administration servers 130 can then communicate the results of its validation to the content author 160. If the content needs modification the author can attend to this at step 256. Once the author is satisfied that the pages are sufficient for his purposes, he can then submit the completed pages for hosting on various nodes. The content author 160 need not necessarily be restricted in their presentation of information since, it is possible for the author to host only one or two of their most significant pages on the nodes, and hyperlinks can be provided to additional pages held on the content publisher's own servers 132. This is possible because the node will, for suitably authorized customers, enable them to establish an Internet session via the communications capabilities held within the node. Such flexibility is balanced by cost considerations since the user will in this instance generally be charged for access over the Internet connection: thus there is an incentive for businesses to pay to host promotional content within the nodes so as to attract the widest possible audience.

Following successful validation of the content at step 254, the publisher then proceeds to step 258 where the content author is presented with a selection of nodes in which the content may be hosted. In a preferred embodiment the nodes are represented on a map such that an author can select, depending on the scale at which the author views the map, either nodes within a geographical area, for example within a town or city, or if the map is viewed at higher resolution, clusters or individual ones of nodes. The software tools used for node selection may also include demographic information, so that a business can select, down to the level of individual nodes, those that they judge best represent their target audience. It follows, from this hierarchical approach to presenting nodes, that under certain circumstances a company could choose to use such a system for a national launch of its products although it would be envisaged that such blanket covering using this network would incur a high financial cost to the content author. Following selection of the nodes at step 258, together with selection of the date range for which the nodes will hold that information and optionally the time at which that information will be presented, control then moves to step 260 where the client is billed, and then to step 262 in which a registry 182 is updated. The registry structure will be described hereinafter, but for the moment it is sufficient to indicate that the registry contains a formalized and searchable description of the goods or services offered by the content author so as to facilitate and provide structure to a search process which may be initiated by a user. Control then passes to step 264 where permissions associated with the content author are set up and stored. The permissions define whether the content author can male changes to the content hosted on the nodes. Such permissions may allow for periodic or even continual update of relevant data. Thus, for example, a hotel might regularly update the number of beds that it has available and such update could come automatically from the hotel's own reservation system. The permission server might also generate a shared secret known only between itself and the content author such that it can validate that a person seeking to update the content of a page is a permitted person. The shared secret may, for example be a one time pad thereby preventing a malicious individual from observing a session between the content author and the permission server and attempting to gain authority to alter that content by implementing a replay attack.

The permissions set in step 264 are maintained within a permissions database 184 held within the administrations servers 130. A copy of the content hosted on a server, together with permissions and billing information may also be maintained within an administration database 186 which can be used to trace a history of events occurring within the communication network if, for example, these are required for verification by some authority, for example the police.

Once the content permissions in billing has been established, the content can then be migrated to the selected nodes. However, at this time, another layer of checking may be involved. This is because, unlike the Internet where the user generally browses the Internet from their own home, the nodes are typically owned or under the authority of a land owner or similar entity. Thus, for example, those nodes which are provided in street furniture will be under the authority of the relevant local authority or highways agency. Such governmental institutions may have restrictions on the sort of content that is allowed to be hosted by nodes within their control. Thus, as a matter of government policy, advertisements for tobacco products may be banned. Similarly nodes situated near schools may be subject to controls implemented by the school authorities and may have a blanket prohibition on offering pornographic content. Therefore attempts by a content author, after having selected the nodes and received their permissions, to place content into the nodes via the managing servers 115 may, depending on other operational conditions be allowed without further checking or alternatively require a further level of scrutiny by the servers in order to apply rules dictated by the node “owner”. The term “owner” is used to include the possibility where the node is strictly owned by one operator but permissions concerning the content that the node might post are determined by other bodies, such as education authorities, highways agencies or local authorities as described above.

Where a further level of scrutiny is required, this can generally be done automatically since any content author who deliberately lies about their content in order to post unsuitable material could, upon detection of this action, be banned from the network either on a temporary or permanent basis, or subject to contract may be fined. Once content has been provided by the content author 160, optionally using a bespoke publisher 182, to the management servers 115, the servers can then propagate that content to individual ones of the nodes 110, 112 and 114. In this context, the nodes act as embedded content servers. Each node/server has stored within its cache a local copy of the content that the author 160 wishes it to host, together with relevant extracts in its own node registry such that local searching can be performed using the data processing capabilities within the node, or the registry can be transmitted to a user device which can search the registry or the search can be started in the node and refined in the user device.

In order to provide real functionality to users, it is necessary for them to be able to sift the information held in the local cache and to access useful information from it. Such a search process could be performed by sifting through the web pages provided by each content provider looking for key words. A defined registry structure however, is advantageous to use in order to collect information in a consistent and searchable manner. The registry therefore provides a linkage between the data content and the search mechanism. The registry is divided into a series of nodes, and each node within the registry corresponds to a set of data files that comprise the content pages. The entries in the registry node summarize the corresponding content of pages and it is the registry nodes that is searched by the search engine. The entries within the registry can be formed from a mixture of predefined terms which in effect can act as tags and these tags can themselves be associated with attributes.

FIG. 9 illustrates an example of a node entry which may be associated with a hotel. Comments concerning each entry are provided in order to facilitate the understanding of the entry. A first portion 300 of the registry entry contains system information, such as an identity of the author, the identity of the registry node (essentially an index), the identity to be invoiced if, for example, the information to users is being presented on a “per hit” basis, the expiry date for the node entry, the date of the last revision, the identity of the person who made the last revision, and, where appropriate, a title.

The next section, 302, contains contact details for the business. These contact details are fairly standard and hence include the street address as broken down into name of business, two address lines, town or city, the country or state, the postal or zip code and the country identity, together with phone, fax, e-mail and web address details. The next section, generally designated 304, provides specific information concerning the services offered by that business. The first relevant entry 306 is a predefined word, selected from a list of business descriptions, which in this example indicates that the business is a hotel. An attribute may be associated with a description of the business as being a hotel, and such an attribute might be a quality or star rating for that hotel. Further information for that hotel might then be given. Thus, for example, the block of data generally designated 308 refers to a series of rooms that the hotel has. The word “rooms” acts as a search key. Information about the rooms is then provided using other predefined search terms. Thus, the block 308 indicates that some rooms are available with a room tariff of between £40 and £48 sterling. Each of these rooms has a sleeping capacity of 1, i.e. it is a single room, and the quantity of rooms available equals 70. Therefore 20 of such rooms exist. A vacancy field indicates that the three rooms are vacant for today. A second block of data, generally designated 310 gives details of another series of rooms. In this example these rooms have a tariff of between £60 and £80 and a sleeping capacity of 2, i.e. they are double or twin rooms. The quantity of rooms in this category is 40, and 6 of these rooms have vacancies. Rooms which are somehow designated special, for example penthouses or honeymoon suites may be detailed individually. Thus the next block of data 312 refers to a specific room which, within the hotel has been given room identity 3 and which has a tariff of £70 and a sleep capacity of 2. The data indicates that this room is currently vacant. Such individual room specifications would provide the user with a greater degree of certainty, since it would be possible to effect ‘offer and bid’ contracts between hotelier and user, in which a user could instruct his/her device to book and pay for that individual room, and receive from the hotelier a firm booking confirmation: the complexity of the registry entries is simply handled by a computer. Thus hoteliers using such specific features may enhance their business by ‘clearing the market’ for hotel rooms. Similar data is provided for a further room designated room 4 as set out in the block 314. Another block of data, designated 316 refers to the facilities offered by the hotel. In this example, the block 316 refers to the car parking facilities, as designated by the use of the keyword “car park” and attributes indicate that secure parking is available, that off-road parking is available but no sheltered parking is available.

If the hotel has a restaurant, data about that restaurant may also be provided. Such data is represented in FIG. 10. Inspection of the data shows that this restaurant has a seating capacity of 40 and has an Italian style of cuisine. Opening time data also shows that the restaurant is open for lunch everyday between noon and 2 pm and that according to the booking system 15 vacancies are available for lunch today. Further data, generally designated 320 shows that the restaurant is open in the evenings from 1900 hrs to 2130 hours on Monday, Thursday, Friday and Saturday and that 6 vacancies are available for today. Special events may override the general opening and closing times and block 322 indicates that the restaurant will be open for lunch time on the included date of 25 Dec. 2005. A further block of data 324 modifies the opening time to show that the restaurant is shut by virtue of exclude dates, on the 24 Apr. 2005 and the 26 Dec. 2005.

It can be seen that, such a registry structure, allows each node to hold a quantified amount of data concerning the business, where that data need not be presented in any specific order, with a proviso that within a block data may need to be presented in a specific order, but which also still allows that data to be searched efficiently because the data tags have been defined in order to create an efficient search space. One of the advantages of such a search mechanism, and its use of an XML style presentation is that the search categories can be modified in order to improve them over the passage of time.

The user device includes a “browser” within it and which is adapted to male use of the registry to facilitate searching. The browser can hold several “pages” and these are presented as tabs such that the user can select a page as the active page for display as a “point of focus” and/or processing purposes. As an alternative to selecting a specific page, the browser may cycle through the pages.

The browser may also allow a user to define and store several criteria, and may repeatedly repeat the search and present new results as new matching data is found. The browser may score or rank the data so as to provide only a suitable number of hits and/or hits in order of relevance. If the number of matching results is relatively low, then results from business located relatively far away may be included. However if the number of hits is relatively high, then the scoring will be tightened, for example by including a penalty based on distance between the location of the business and the current position of the user (which can be looked up and calculated based on the ID of the node or transmitted explicitly from the node to the user device).

The user can define their own presentation rules, as to whether new data appears at the top of the “point of focus” such that when the user returns to the page that the search is displayed on then the new results can be brought to their attention, for example by being displayed at the top of the page. As an alternative, the last seen data may remain on a given page in an un-updated form and the user may toggle the page between the un-updated form and the updated form.

The user may also mark entries such that they are always displayed, or indeed never displayed until such time as the rules for displaying entries are modified by the user or a new search criterion established.

As noted before, different users may enjoy different service levels. When a user first signs up to the services offered by the present invention he may be invited to select, and pay for, a given service level. The user may then be issued with an identity which directly encodes their service level. This obviates the need to check a user's service credentials each time then communicate with a node. However, statistical checking of users may be performed and user identities may be periodically updated without knowledge of the user in order to prevent hackers seeking to gain access to services that they have not paid for.

The system that is described above can be extended to describe all other sorts of business and activity that an individual or organization might want to have present within the content of a node.

It should be noted that the structure of the registry entry is centrally controlled, so that a content author may only select elements for inclusion in the registry that are in the current structure. The structure and allowed words will be a matter of continual update, and will be published over the Internet in the conventional way. The content author however is not bound to include any more fields than he/she wishes, and so there is no need to include null entries in data fields that are not of interest.

An additional advantage of this system is that the category word, for instance HOTEL, sets a context for the qualifiers, which as has been described are in the form attribute=argument, and so where in the normal usage of language there might be ambiguity in the meaning of a particular attribute, the context provided by the main word may be used algorithmically to resolve such ambiguity without need to use separate words. So, for instance, the word ‘bed’ can be resolved to have a common meaning under all contexts that imply accommodation (e.g. HOTEL, MOTEL, GUESTHOUSE) but a distinct meaning under the context FURNITURE_STORE, and thus the software would not offer prices on beds in a furniture store when the user was seeking somewhere to stay.

Another aspect of this invention may now be described. The nodes are in dynamic communication with a plurality of information sources, and these sources may update their information, or subsets of that information, as needed or regularly. As is clear with computing equipment, such updates may happen very frequently, and so if a digital image is considered as a subset of content, and it is updated at a video frame rate, for example, then it becomes a live video feed. The concepts of ‘real-time’ and ‘updated’ content thus merge with the only distinction being the time since the last information update took place. However it is understood that all information on a node is referenced in the registry.

Thus the combination of the specific information in the registry, and the dynamic update of content make an important feature of this invention possible.

Conventional web pages, such as available over the Internet, are essentially static information, and where they relate to real-time events that relation has to be interpreted and acted on by the user. However, as has been described above, the browser of this invention can use pre-selected user criteria to continue to ‘harvest’ information without user intervention.

In an extension to that, a subset of the software of the browser (or harvester) can conveniently be described as a ‘difference engine’. This brings to this invention the concept ‘I am here and now, and I need information about that activity which is there and then’ (i.e. in a different place and in the future).

An illustrative example would be a user with a booked plane ticket, driving to an airport. The difference engine element of the harvester software could be invoked, applying to a ‘point of focus’ which is the departure airport. Information relating to the flight, obtained via the registry, would include the earliest and last check-in times, and the user would confirm these to the difference engine software. The user might be using an ‘off-airport’ car park, and so the user could enter, again from a specific entry found in the registry entry for that car park, a ‘time to departure’ time, i.e. the advised time between arriving at the parking, and arrival at the check in: the software would subtract this, i.e. derive earlier times, from both the earliest and last check-in times. These times would become way-points for the journey.

The software would ‘know’ the given position of the node that he was communicating with and the time, and so it could compute, using a user set or average speed, or an advised speed from information on the node, how much time margin, if any, the user had to meet the time window for check-in.

As the journey progressed, the user could be advised, in many different formats of choice, the rate of progress, and it could factor into its communications traffic speed information for the route ahead derived from real time data taken from the nodes, in conjunction with standard routing information, which might be part of the content of a node, or built into the difference engine software. A useful format of choice might be ‘you are running 40 minutes ahead of last check-in time’.

The difference engine would have the flight number as a parameter, and could periodically interrogate the road-side nodes for flight information. As previously described nodes remote from the airport would not have this information, and so it would be requested at user cost via the Internet connectivity of the node. As the user neared the airport it is possible that the airport would, at its cost, arrange that flight information for the next few hours be hosted at all near nodes. As noted above the difference engine will readily find that information because it has a unique reference given in the registry entry process, and so that reference is unchanged whatever route the information comes by.

The utility to the user is that if for instance a flight is delayed and the user is late, then he knows he has more time to make the flight. Similarly, if flights are re-routed, for instance during bad weather, the user can change plans and make for the new airport.

It can be seen that this ‘difference engine’ software package is useful in innumerable other applications, for instance catching trains, or going to a restaurant, meetings, theatres and so forth. It can also be used as a routine navigation tool, thus it is in receipt of up to date traffic information, and it could be linked with mapping information to calculate several alternate routes and to offer one or more diversions that might save time. Such a facility is particularly of use to delivery and logistics companies. Not only can they route their scheduled delivery according to actual traffic information, they can download new pick-up and drop off locations whilst en-route, and these can be integrated and optimized.

There are applications where it also works the other way. The difference engine can send ahead to the airline information that the passenger will make the flight, or that the restaurant table or hotel bed will be used. If the user is not going to be able to take up an opportunity, then in general the supplier is open to let this to some other customer, and so there is cost saving, and since there is now real time contact the first booker might receive a partial refund.

An alternative user device (not illustrated) for use in a taxi-cab, bus, train, ferry, plane or hotel lobby will now be described. The device comprises a single data processor, memory and wireless communication interface. In the example of a bus, these elements may be housed in a box on the dashboard. Coupled to these elements are a number of display devices, which may be installed for instance in the backs of the bus seats, or in the roof lining.

The driver of the bus might have a switch, or the system might have a GPS or a flux gate compass that could determine whether the bus was going to or coming from an airport such as Heathrow. If it was going to Heathrow then it would know the time, and as a relatively trivial example the difference engine would be pre-programmed to know that its ‘time of interest’ for arrivals would be those up to half an hour before the expected arrival time at a terminal, and say one hour after. For departures its ‘time of interest’ would be those flights say 45 minutes before the beginning of check in up to actual departure. The screen could then flip, exactly like those in arrival and departure halls in the airport, firstly between arrivals and departures, and then between terminals. Passengers arriving on time for departures would be reassured. People meeting arrives could be directed to the baggage claim for a flight. Users with WAP enabled phones, PDAs could be patched through the bus microwave (typically) 63 GHz link to pick up particular information or use all the other facilities. A public terminal might be provided for those who do not have their own device. The bus might also use the link to stream film or audio content, in exactly the way described above for a house.

An alternative user device (not illustrated) for use in a taxi-cab, will now be described. In this example, the user device is a computer with a code which is issued which authenticates it as a taxi-cab. Content users putting content on nodes can then authorize the node to supply content to the taxi-cabs, and to credit the taxi-cab driver for taking the content. So if a cab driver selects West End shows within 3 km as search criteria, then the automated browser downloads information on these and puts them on screen, then passes a verification code back to the node, which collects this up with all the other billing messages to generate a credit.

The taxi-cab driver is likely to have a good idea what his clients appreciate most, so he uses the search engine to select accordingly. The taxi-cab driver gets a small credit for the content, but a big and significant credit if someone transacts something from his taxi-cab. It also provides feedback to advertisers: if they believe that the taxi-cab drivers know what they are doing then they can get direct statistics of the selection made by studying the micro-payments.

A further embodiment of this invention is now described. It has already been described how the nodes may charge in various ways for access to a certain element of information, and, via a systematic relay of this information back via the ‘Managing Servers’ to the ‘Billing Servers’, customers with accounts with various operators of the system, or organizations in partnership with the operators, can charge the access to this information to the user in a regular way, for instance monthly. A further aspect of this invention is that it can now be used to enable many different and new business models, and also to provide a channel for billing of other commodities that a user might purchase.

Many of these new business models can be grouped together under the title ‘pay-as-you-go’ and is supported by the network infrastructure of the present invention. In these models features of this invention include: the means of estimating, or costing some other service or commodity, as well as the means for charging for it. One example would be motor insurance. Currently insurance brokers have to base a premium estimate on a combination of ‘hard facts’ supplied by a user, such as sex, age, home address and driving experience, and some other statements, for instance as to the general purpose of the insurance, loosely classified as social domestic and pleasure, or business. However insurers generally have a far better understanding of risk if they could understand the individuals driving patterns. Use of this invention allows the user to have motor insurance on a ‘pay-as-you-go’ basis, combining regular, say monthly billing, and charging which is variable according to some agreed formula, with usage. According to one formula a driver might pay a fixed monthly fee, but might receive each month an estimate of the following year's premiums if the driving maintained the same pattern. According to another formula each month's charges might be a direct representation of the assessed risk: these are examples only and not exhaustive. The insurer could log for each driver their driving patterns and habits by receiving information from the network of nodes. On motorways and highways the posts could determine the user's habits in respect of speed limits. Driving through areas with high collision risk and parking in areas with high theft and damage risk, and long driving days might all incur premium penalties, whereas those who drove only on low congestion country roads, or who drove at off-peak times would benefit by lower premiums. Insurance companies and the police could also use the invention to track vehicles when it is known or suspected that they have been stolen.

Other examples of new business models enabled by the invention would be the creation of a ‘value priced’ market in services such as parking: in certain areas public authorities or land-owners could allow users in vehicles to bid for parking in sought after locations or at peak times, or to match certain events.

Further examples of this extended use would be: as connectivity to a building to enable utility meter readings to be recovered, which could then be billed out as described. This could be combined with or extended to monitor houses, for break-ins, smoke or fire, damp or flood, and thus to generally protect unoccupied property.

Connectivity could also be to vending machines using the payment options already described so that users could buy from the vending machines without using cash by charging it to one of their accounts supported by the invention. Computer and arcade games, lotteries and gaming via the user device can be offered in a similar way. Provision of other facilities might include message boards, for instance for ‘dating’, and also electronic graffiti areas: of course since these are electronic users who might be offended would be completely able to avoid seeing the material, whereas those who now generate damaging graffiti might be attracted to the new medium.

Smaller wireless devices could be given to children, or attached to pets, so that they may be tracked by the network of nodes so as to avoid or prevent loss or abduction. This could be extended so that groups, such as school or family parties could identify themselves as a group to the network, and their passage past each node would be monitored in case any member becomes lost or disconnected. Other members of the group would then be able to interrogate any node, authorizing a search mode (permission for which would be implicit in each member of the group initially registering with the network) by which the lost members could be located. Similarly the tags or bracelets uses to restrict criminals who are allowed into the community on parole or on community punishment schemes could use the network of nodes to report into the controlling authorities and to monitor the criminal's location.

In further implementations, an ASP (Application Service Provider) may own, license or rent bandwidth and memory and processing at a node. Thus, cache content at the node may be used by an ASP to store and make resident the data content at the node. The ASP may then, on a pay as you go basis, download executable programs to users via their devices (mobile or handheld). Similarly, an ASP may execute programs that run on the content cached at the node. The applications and the cached content may be fractalized and distributed among a plurality of nodes such that if one node ceases to perform or is down, the application set is not lost. One application may include, for a campus type environment, any application set relating to the secure storage and distribution of medical records and patient care information. Thus, for instance, such healthcare type applications may be propagated to and made resident on nodes located at schools and school districts, colleges and universities to enable local diagnosticians, e.g., a school nurse, to diagnose potential illnesses in students who exhibit certain symptoms. In such an example application, a school nurse may access a node through a wireless equipped computer and retrieve information that is relevant to the student in the school district, for instance. In another example scenario, a social worker may access a psychoanalytical program in order to diagnose a student having emotional or behavioral problems. In each instance, a user may download an application from a node on a pay-per-use basis thus, avoiding all of the problems associated with accessing such diagnostic tools and aids through conventional network communications means. Moreover, doctors and other healthcare service providers, e.g., hospitals, can provide patient information to be stored at a node that may be securely downloaded on-demand.

As mentioned, such applications may be fractalized, for redundancy, and more importantly for security reasons. Moreover, the data content may be fractalized and stored on different nodes such that if content at any one node is compromised, security may not be breached.

The nodes may be additionally considered real property and/or an asset as it may mounted to an existing structure (e.g., a house) or buried in the ground, it may be programmed to cache relevant information related to the structure which said node is located. Thus, for instance, a home placed on sale may carry a node equipped with cache having downloaded data content including information pertinent to the sale of that home. Such cached content may comprise, but is not limited to: a description of the home/property for sale, the lot layout, floor plans, video tour, financial analysis and all cross-linking interfaces, e.g., lender information, attorneys, insurance companies, etc. Being mounted on a house or building itself, it is considered real property and may be sold with the house or building and financed in the mortgage. Thus, not only does the provision of a node at the home provide high-bandwidth for Internet connectivity, as a node owner, an annuity or revenue flow may be generated to the home when the node is adapted to provide a service or enable commercial activity, e.g., store/download content and/or applications for third parties willing to pay for that storage.

Extreme flexibility is provided by homes or residences provisioned with a node, in that it provides a convenient way to measure and monitor environmental conditions, via a sensor network or sensors located at the node, and execute optimization applications for system and devices employed at the home, e.g., water sprinklers, home energy usage/temperature control, etc. Thus, utility companies can read measurement and upload data immediately back to an application, for example, housed at that node or nearby node for eventual uplinking to the utility company.

Further applications including expanding the cache capacity of the home node in order provide streaming entertainment capabilities, e.g., downloading information to the entire home such as streaming video, audio or A/V. Thus, the nodes function as a server for the home of such content.

The communications network of the invention has the property of being very flexible and expandable into small-regions by adding relatively low-cost nodes called “posts”. Post cost and installation fees are paid for by the immediate needs of a relatively small cluster of users. In essence, a new franchise of this communications system is easily affordable by one or two beneficiaries. Continued revenues are then accrued for a variety and large number of low-revenue small usages of the system. Flexibility of installation and expandability of the system based upon fast post-post communication and ability to use memory at each post to cache large amount of small, but useful pieces of information is advantageous.

For example, an owner who wishes to sell his/her house contacts a local franchise or national realtor organization that would place a post at that property complete with sales information (description) of the property for sale. Potential buyers may use wireless handheld computers or a tool leased or loaned from a realtor to receive information about the property from their car. The post would be a permanent fixture in the house and its cost would be assimilated into the basis of the house being sold. In communities with high real estate turnover, posts could heavily populate the community within two or three years. Posts with technical improvements (like more power for longer transmission range, more extensive caches or new wavelengths for communication or back channel communication) come into the local cluster of posts as new sales occur. The new homeowner, having purchased a house with a post, could make use of other post value such as security or water leak monitoring . . . or as a local Internet connection or rich source of local information. Multiple posts in a community might allow a web of monitoring and reporting of local conditions such as theft rates, houses for sale, school information, town meeting information, pizza specials, or civil defense information. For example, a person who sees some suspicious activity taking place in their neighborhood may upload suitable information to a node that may be forwarded to appropriate authorities. Besides enabling a neighborhood monitoring function, the individual comprises a first line of intelligence gathering for more serious potential threats.

Memory in the posts coupled with fast post-post communication allows a network of multiple posts sharing their collective memory to allow storage of large and extensive data records. For example, on a suburban street with ten posts, each post might store a different ten Gigabyte movie. Any person on the street might access and view the movie contained in a local post so that ten movies are available even though each home's post might only be capable of storing one movie. Multiple posts provide redundant delivery of post information if one post fails so that service is continuous to a homeowner despite failure.

This communication system is different from laying fiber (or cable) to a street and the significant costs of burying and connecting the fiber before any single user can be serviced is avoided, as is the risk of the basic service being installed in an area where it won't be used. Furthermore the legal complexities of obtaining rights to install physical communication media over property owned by multiple owners is avoided. A single post with a single back channel can be added for a cost within the range of value accrued from one or more commercial or government uses, and other value immediately realized by the user from the post's communication and caching ability. As more posts are added, each post's value increases as neighboring posts share memory caches and communication reliability is increased by the redundancy of multiple communicating posts. Since costs are low, improvements in communications technology to a back-channel can be simply realized in a net-work of posts by adding a small number of new posts with the improvements that can then be shared among the communicating posts.

This communications system is different from a system of receivers that download satellite information in several respects. First, the capital cost of the satellite is avoided (although a satellite may be a communications back channel for one post in a cluster in rural areas). Secondarily, high bandwidth communication among posts will exceed the bandwidth available from a single satellite as well as avoid communication uncertainties (signal loss) due to the limited power of the satellite. The cost of a post and its installation is comparable as the cost of a satellite receiver and its installation, suggesting that the same quest for eyeballs that causes satellite companies to install receivers at a loss could similarly fuel a franchise that installs posts and their back channels.

In highly urban environments, post installation can be very simple and low cost due to the short distance between neighbors minimizing communications power or antenna adjustment. Furthermore posts can be installed inside a house or a garage with the advantages of their being out of the weather, away from vandalism and able to run or recharge batteries from conventional electric power mains in the house.

In rural environments post-to-post communication may take the form of communicating with mobile posts in vehicles to move large quantities of information, like a movie, from one post that is out of wireless range from another post. Obviously, a rural area has a lower density of users and will be less rich with local information or revenue possibilities from large numbers of users. Use of vehicles for “packet transmission” where data is physically carried in memory on vehicle and connected to posts as they pass by with limited-range wireless connections can provide information security as well as minimize the need for a continuous chain of posts in sparsely populated areas. Transmission can also be vehicle-to-vehicle to maintain local information in a local region by having vehicles leaving the region pass the information via high bit-rate wireless transmissions to vehicles entering the region.

For secure commerce transactions, private talk networks, and general communications among users, and user types (e.g., police department networks, and fire department networks) use and employment is made of applicant's co-pending U.S. patent application Ser. No. ______ corresponding to European Patent Application No. EP05252250.5 entitled “Method and Device for Communicating Using Random Codes” filed Apr. 11, 2005 [attorney docket P106603EP; 19145] the whole contents and disclosure of which is incorporated by reference as if fully set forth herein. That is, the communications system of the present invention, enables entities to host (locally cache) data content at one or more nodes, a plurality of nodes forming a cluster, with at least one node back haul connected to a network such as the Internet. Users may, through their conventional mobile and hand-held wireless devices (implementing Bluetooth, WiFi 802.11 protocols, for example), initiate the downloading of content from a node or node cluster to the user device, or receive Internet-based services via the user device. In one embodiment, the user devices are furnished at manufacture (i.e., stored in erasable memory) or may be furnished with an add-on card or attachment (flash card, usb key, RFID, Bluetooth, for example) with a list of random codes, e.g., on the order of a billion “large” numbers (e.g., 128 digit codes (base 10)). These codes are additionally maintained by a verification service accessible by the network server device at the node or cluster in the network. The verification service maintains a registry of subscribing users and the list of random codes associated with that user's device. Additionally associated with each user is a predetermined service level that a user has subscribed to for transacting within the network. Subsequently, when a user initiates a wireless transaction with a node in the network, the large number code is wirelessly transmitted to the server which accesses the verification service to verify that the user device that is communicating is authorized to conduct a particular transaction. The random code may be either transmitted in the subsequent communication, or used as an encoding key in the subsequent communication. In response, the server can verify the particular device with each code associated with a device and device owner (user). Additional transaction authorization is provided to ensure the operator of the device is indeed the owner of the device (or at least the authorized user). This further authentication may be implemented by requiring a user to enter a PIN (ID number) or provide biometric data, which may be used to verify that the user/device is authorized to conduct a transaction with a host node.

According to a further aspect of the invention, there is provided a transaction enabling device, akin to a credit card, adapted for wireless connectivity in the communications network of the invention to enable users to conduct transactions with a host. Referred to as a ubiquitous or “UBI card”, this device is carried by users and provided with means to communicate with a back-end dedicated server or device for receiving requests for content and authorizing transactions for a host at a node or cluster. The card is adapted to deliver the highest level of security in commerce, information exchange and access. It includes a multi-layered lamination encapsulating a passive “RF” (radio or multi-frequency) transceiver circuit or chip in conjunction with a small 4-6 point keypad allowing integration of a PIN or personal identification number for additional security. Preferably, the RF chip is encoded and/or programmed at manufacture to correlate to a defined “Large Number Active Security” algorithm found within one of a large set of acceptable, randomly generated codes in the communications network.

In operation, when a consumer comes into active proximity to a network node, the network will recognize the passive chip embedded in the UBI card through automatic synchronization via a multi-frequency transmission activated within the passive RF tag by the network. This is just part of the authentication process described in above-identified commonly-owned, co-pending U.S. patent application Ser. No. ______ [attorney docket P106603EP; 19145]. A consumer who wants to then purchase any product or, download content from a node, would depress the keypads on the card in the proper sequence to pass final authentication. Once authentication is complete, the transaction is authorized and the purchase is simply deducted from a secure financial account associated with the consumer's UBI card in a similar fashion to credit card use in e-commerce transactions today.

Preferably, as shown in FIGS. 11A and 11B the UBI card 400 has the following components:
1. A user keypad 405 for activating the UBI and entering a pin that confirms the proper owner before enabling a transaction.
2. A block of flash memory 410 (e.g. 0.2 megabytes) which is programmed to contain a plurality of long numbers (e.g. approximately 10,000 20-byte numbers) used as in the one-time pad for assuring confidential transactions. The memory must be erasable, or at least provisioned with functionality to erase segments of the memory after it has been used once.
3. A microprocessor 415 and associated number generation hardware as described in United States patent application corresponding to European Patent Application No. EP05252250.5 entitled “Method and Device for Communicating Using Random Codes” filed Apr. 11, 2005 [attorney docket P106603EP; 19145], which generates codes via the coding port described therein, with a device pair in any of the described modes and is provisioned with an unchangeable program in ROM (read only memory) 420 that defines the loading and use of the one-time pad. The one-time pad and unit identification number is only programmed once during or after manufacture and before use. The programming operation requires loading 500,000 bytes of random numbers either at manufacture or at the time of placement into service. WIFI can be used for the data loading operation.
4. A low-power processor 415 is programmed for reading the keypad, accessing flash, and conducting transactions and communication protocols. All programs reside in permanent ROM and a small amount of RAM (not shown) is additionally available for temporary use in normal operation. The processor is able to access the flash by pointers and to erase used sections of the flash. The processor preferably has a low power sleep mode and is awakened by pressing key on the keypad.
5. A WIFI transceiver 425 and antenna 430 for conducting normal WIFI communications at distances of up to 200 feet. All communications are originated by the UBI card 400 so that external systems cannot wake up or begin transactions with the UBI. It is understood that conventional communication protocols are used in the UBI system to minimize disruption to existing standards or available WIFI hardware.
6. A battery 440 for powering the unit for up to 10,000 transactions. Each transaction is estimated to require a small number of milliwatt-hours of power. When the processor is sleeping power consumption is in the microwatt or nanowatt range. Preferably, the card 400 is designed to have a life of about three years with an average of about ten transactions per day or 10,000 transactions.
7. A housing 450 to contain all the components and keypad 405 that is capable of preventing access to the flash in the event a unit is lost. Access may be prevented by destructing the flash during access. The housing additionally allows for the placement of logos and written owner identification information.
8. One or more visual indicators 445 (e.g., LEDs, liquid crystals) to provide feedback to the user that the unit is operational, in a WIFI environment, and that a transaction was properly completed. In advanced forms, the visual indicator may be a small 1 by 10 or 2 by 8 character screen that can display a transaction reference number or the amount of money to be or that was exchanged.

Such UBI card components may designed in a variety of physical configurations or form factors, e.g., from key-chain devices that look like an electronic car key to thick credit cards. Accordingly temperature, shock, acceleration and moisture limits are included in the physical design.

Although not a component of the card, the UBI system requires access to WIFI communications, and a link (generally the Internet) from the WIFI receiver to a centralized computer (this could be a regional computer or a local computer for the facility requiring secure identification. Such a computer has a subsystem that securely stores each UBI card's twin one-time pad. Various secure methods as suggested in the commonly-owned, co-pending U.S. patent application Ser. No. ______ [attorney docket P106603EP; 19145] may be used for generating the one-time pad and its counterpart (twin).

Further operational details of the UBI card 400 include, but are not limited to:
1. The ability to “wake up” the microprocessor for a period of several minutes or until a transaction is completed in response to a user's touching any keypad key.
2. The ability to enable the user pin number to be reprogrammed whenever desired by the UBI user/owner of the card.
3. The ability to initiate transactions by the user entry of the pin number on the keypad. 405 The user can specify whether more than one transaction can be performed with the card or whether it is restricted to one transaction per activation. This allows a user to enter the pin, authorize a transaction and give it to a host or other business entity to complete one and only one transaction. With an advanced display the user can also specify the amount or limit the amount of the transaction with the keypad.
4. The ability to initiate and conduct a transaction in a WIFI or “post” environment. The UBI sends out a query to the local communications system which upon receiving a response causes the UBI to send it's identity number and the type of transaction desired. The transaction is then entered, confirmed available, and the pad numbers exchanged according to the techniques described in the commonly-owned, co-pending U.S. patent application Ser. No. ______ [attorney docket P106603EP; 19145]. Preferably, appropriate security measures in the UBI card prevent limit unauthorized interactions such as a limit of three transactions per pin entry or three uncompleted transactions with a financial institution. Conventional security measures such as encryption or repeated transmissions may be applied to the UBI communications to prevent unauthorized knowledge of the amounts of finds or user ID numbers being sent through the card. Additionally, communication ranges may be limited by low-power RF operation or even by use of line-of-sight IR communication.

This method for providing highly secure transactions provides better authentication than a personal signature (which could be forged) and as such can be recognized by those in the business as an “in person” transaction affording the vendor or supplier of the goods/service the least costly transaction fee due to the heightened security and virtual elimination of fraud.

In another embodiment of this invention, it should be recognized that this same authentication process can be applied to the exchange of highly secure documents pertaining to private, medical, government or military information where absolute positive identification is a requirement.

In another embodiment of this invention, the UBI card facilitates secure access into any physical location, be it corporate, military or private sector, and becomes a least cost alternative to the myriad of systems in use today. An additional benefit to the secure network integration is a complete time-stamped record of all access and exit traffic to and from a facility.

In another embodiment of this invention, users of the system could easily access a comprehensive set of private or public transportation systems such as buses, trains, boats, taxis, planes and be automatically charged for the specific time or distance traveled without the need of stopping at a ticket booth. This same design would also be applicable to a plurality of venues such as sporting events, movies, theatres, theme parks and other entertainment related concourses.

In another embodiment, summarized exchange reports can be made available to the consumers on a periodic basis. Another benefit that the system offers is an actual accounting of all products viewed/bought or experienced through the system. This data tracking system would lend itself to a first of its kind accountability to the advertisers and/or promoters to bring hard evidence to the effectiveness of their ads and the ad dollars being spent by their clients. The creation of a “UBI Top 100” list or a “Best of” list would provide real time feedback and establish a defacto public endorsement of any of the best products or services as viewed or experienced by consumers.

As mentioned, the UBI card is a wireless device for assuring the identity of a person in financial transactions or other security situations using a large single-use table of numbers that provide confirmation that a specific UBI is in use. The UBI card can also be used as a second channel of verification for a credit card transaction.

In addition to the applications described herein, the communications network and UBI transaction mechanism of the present invention can be used for a variety of hosts and application service providers relating to, but not limited to: Public Sector/Public Safety applications including, for example, a Transportation Dept. (e.g., asset tracking, pay as you go buses, taxis, subways, ferries, trains, etc.); Municipal (Council); Legislative (e.g., for receiving Public feedback or for polling); a local Chamber of Commerce (e.g., promoting the City/Town, current events (e.g., post every event that is coming up in a time interval) and demographics (e.g., downloading community information for potential home buyers such as what is the make-up of the town, schools, houses of worship, etc.); Parking (e.g., Automated metering, space locator (e.g., downloading information regarding availability of parking space for a car in the city); Local Information (e.g., locations, prices and availability of Restaurants (drilling down into menus, Hotels, Motels, B&Bs, Clubs and Entertainment); Emergency (e.g., Priority traffic light switching (e.g., preventive maintenance; prioritize traffic by controlling lights, e.g., if a emergency vehicle needs to get through); Emergency vehicle locator; Traffic optimizer (e.g., the network may be used as an extension to vehicle navigation systems (e.g., Magellan) the system will know the current traffic patterns and know which routes are best that can be communicated to a user's mobile device); Citizen alert (e.g., Broadcast messages, Individual “Help Me” calls, etc.); Homeland Security (Home/Office) applications: Sensor monitoring (e.g. air, water, sound, shock, seismic, radiation, plume detection and direction and, other security systems); Corporate applications: e.g., banking/payment/transaction, Private Voice Networks, Security (e.g., Document Laptop); Employee Tracking, Asset Tracking, Entrance and Exit Traffic; Retail, fast moving consumer goods (FMCG), Services, ‘Product Finding’/Yellow Pages, Intelligent Advertising (e.g., only advertising to those who care), Data mining, Market trends and analysis, Pilot ads before national rollouts; Logistics/Transport Industry applications (e.g., Road Tolling, Global Track and Trace (e.g., knowing when a delivery is to be made to a home), Telematics, Trains, Planes, Busses, Containers, Highway use, Maintenance and Repairs, embedded scales (full speed weight reports on commercial vehicles); Utility Metering such as for Load Balancing (e.g., real-time feeding (RF communication) of meter information to assimilate usage of an entire town or city, for example, to detect power usage and potentially avoid brown out condition, etc.), historical trend analysis for consumer conservation (e.g., ohmmeter readings collected at the node enabling a consumer to access information regarding costs of their power usage for a period of time, and ascertaining impact if users were to adjust their power usage, (e.g., doing electric drier loads/laundries at night rather in the afternoon) and provide utility company availability to adjust price (e.g., or optimally implement tiered pricing based on time of day), Anti-theft); Broadband Delivery, VoIP; Media applications (e.g., Digital Distribution (e.g., Video, New and Old catalog, Music (e.g., custom play lists by consumer, Load and Go all user favorites); Communications applications (e.g., VoIP, Video Calls, Person to Person, photo albums, Message board, Instant messaging; Weather-related applications (e.g., Node weather stations, Temperature, Humidity, Wind Speed (by product wind chill); UV monitoring (and associated health warning), Severe weather alerts; News related applications (e.g., Traffic Reports, Weather); CCTV; Public Polling; Classified Ads; Auctions; Radio applications, Ad free radio, Genre Specific; Games and Contests (e.g., Name that tune, Retail promotion scavenger hunt); Real Estate applications (e.g., Listings, Local Demographics, Photos/Video, Floor Plans, Specifications, FSBO (For Sale by Owner) including Local Demographics, Photos/Video, Floor Plans, Specifications; notice; Buyers (e.g., Home wanted ads, Search criteria enabled); Renters; Cross promotion of Insurance Companies, Attorneys, Appraisers, Home inspectors, Mortgage Brokers/Lenders, etc.; Newspaper; Daily news; People's Choice or back-feed or audit capability whereby consumer provides feedback as to how the product or service performs (e.g., Top 100 Music, Hotels, Restaurants, Movies, Products, Ads, Consumer Products, Services, Sports Highlights, Entertainment, etc.) based on the number of hits; Classified, Local News from around the world, and, ability to select news from anywhere.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention.

1. A communications system comprising: a plurality of nodes and a plurality of user devices, a group of nodes comprising a cluster, and each node comprising:
means for providing bi-directional wireless communication with at least one user device and optionally a further node device,
a local memory storage means within a cluster of nodes for storing information for presentation to users, and
a processing means associated with a node for receiving a request for said information via said first communications subsystem and in response, initiate communication of said requested information to a user device via said bi-directional communications means,
wherein processing means at said nodes of a cluster cooperatively interact via said bi-directional communication means at each node to access information requested by a user held in the local memory storage means at a node within a cluster, to establish communication of said information to a requesting user device.

2. The system as claimed in claim 1, wherein said local memory storage means cooperatively interacts with a means for providing bi-directional wireless communication with at least one user device for storing and delivering said data content to a plurality of users without intervention of a host personal computer device.

3. The system as claimed in claim 1, wherein at least one of the nodes of a cluster includes a means for providing bi-directional communication with a further communications network, said processing means at said nodes of a cluster cooperatively interact to establish a connection between a user and the further communications network.

4. The system as claimed in claim 1, wherein said further communications network is an Internet, and public or private intranet.

5. The system as claimed in claim 1, wherein said means for providing bi-directional communication with at least one other node comprises one selected from the group comprising: an infrared communications system, an optical network communications system, an RF or microwave communications system.

6. The system as claimed in claim 3, communications network as claimed in claim 1, wherein the information is organized in a searchable form.

7. The system as claimed in claim 3, in which the information is held in a registry and the information is provided via the use of predefined descriptions.

8. The system as claimed in claim 7, in which the predefined descriptions may be modified by further parameters.

9. The system as claimed in claim 3, further including at least one management server means for performing at least one task selected from a list comprising:
allowing data providers to place data on selected nodes;
charging data providers for hosting data on selected nodes;
logging use of the communication system; and
returning requests for further information from a user to a relevant data provider.

10. The system as claimed in claim 1, in which at least one node within a cluster stores audio or visual or A/V media information for distribution to users.

11. The system as claimed in claim 6, in which a content provider stores movies in the local memory of a node for sale or rental to users.

12. The system as claimed in claim 7, further including a copyright protection mechanism in which a key is associated with copyright material and a user can only replay the material if they are in possession of the correct key.

13. The system as claimed in claim 1, in which a user's device includes a security mechanism for validating that a user is entitled to access a service over the communication system.

14. The system as claimed in claim 9, in which the user's device can interface with, or has built in, a key containing a one time pad for authenticating transactions.

15. The system as claimed in claim 9, in which the security mechanism interrogates devices which are in networked communication with the user's device and to inhibit reproduction of copyright material if it determines that any of the devices are unable to uphold protection of the copyright material.

16. The system as claimed in claim 1, wherein at least one node other comprises sensors for monitoring the environment, said node monitoring an output of the sensors and automatically notifying an operator if an event appears to require further investigation.

17. The system as claimed in claim 1, wherein each a user device is located in a user vehicle traveling by a node, said user device configured to receive data content transmitted as high frequency data signals, temporarily cache the downloaded data content at said vehicle, physically move the cached information to different locales and, be synchronized to upload the data content back to another node.

18. A surveillance system comprising a plurality of nodes having sensors for surveying the environment, the nodes further comprising wireless communication devices for establishing communication between the nodes, and the nodes arranged into groups with one node within the group having connection to a further telecommunications network such that a node can send data via the telecommunications network.

19. A media delivery system comprising a plurality of nodes having memory for storing media content, and the nodes can deliver the media content in a copy protected format wirelessly to suitably enabled user devices.

20. A distributed communications network comprising a plurality of nodes and a plurality of user devices, wherein each node comprises: a communications device for establishing bi-directional wireless communication with at least one user device; a communications device for establishing bi-directional communication with at least one other node; and a data processor in association with a local memory for storing information for presentation to users, and wherein the information is held in the local memory in a searchable form.

21. A network according to claim 16 wherein the information is stored in one or more registry nodes adapted to enable the nodes to be searched by a search engine.

22. A distributed communications network comprising a plurality of nodes and a plurality of user devices, wherein each node comprises: a communications device for establishing bi-directional wireless communication with at least one user device; a communications device for establishing bi-directional communication with at least one other node; and a data processor in association with a local memory for storing information for presentation to users, wherein the information includes data enabling a map to be presented on a user device in three-dimensional form.

23. A distributed communications network comprising a plurality of nodes and a plurality of user devices, wherein each node comprises: a communications device for establishing bi-directional wireless communication with at least one user device; a communications device for establishing bi-directional communication with at least one other node; and a data processor in association with a local memory for storing information for presentation to users, wherein the information includes time data, and wherein the data processor is programmed to deliver information to a user which varies in accordance with the time data.

24. A network according to claim 23 wherein the data processor is programmed to monitor a rate of progress of a user device, and to deliver a time margin to the user device based on the time data and the monitored rate of progress.

25. A network according to claim 19 wherein the data processor is programmed to deliver information associated with a specified time of interest.

26. A method for providing content hosting service comprising:
enabling a data providing entity to temporarily store data content to a memory storage means associated with a node of a communications network comprising a plurality of nodes, each node comprising:
i. first means for providing bi-directional wireless communication with at least one user device, and,
ii. second means for providing bi-directional communication with at least one other node in said cluster;
charging said data providing entity for hosting data at said nodes;
providing a registry maintained at a host server associated with a cluster, said registry including a description of data content offered by the data providing entity in a manner to facilitate a search process initiated by a user;
a user subscribing to a service offered to select, and pay for, a given service level, wherein in response to receipt of a user request for accessing said registry via a user device verifying a user subscription to said offered service and authorizing a valid transaction for pulling selected data content according to that user's subscribed service level,
whereby, processing means at said nodes of a cluster cooperatively interact via respective second means for providing bi-directional communication at each node to access information requested by a user held in the local memory storage means at said node, to establish communication of said data content to a requesting user device.

27. The method for hosting content as claimed in claim 26, wherein said content is authored by a business and designed for a node.

28. The method for hosting content as claimed in claim 27, wherein said registry includes a formalized and searchable description of the goods or services offered by the business.

29. The method for hosting content as claimed in claim 27, further comprising assigning permissions to enable updating content at a selected node.

30. The method for hosting content as claimed in claim 27, further comprising: selecting a time and a date duration for which a node is to retain said data content.

31. The method for hosting content as claimed in claim 27, further comprising submitting said data content to one or more nodes via a server device.

32. The method for hosting content as claimed in claim 27, further comprising enabling nodes via said second bi-directional communications means to dynamically communicate with a plurality of information sources, said sources updating their data content, or subsets of that content at periodically or as needed.

33. The method for hosting content as claimed in claim 27, further comprising dividing data content amongst two or more nodes of a cluster, wherein data content is fractalized to enhance security should data content at any one node be compromised.

34. The method for hosting content as claimed in claim 27, further enabling users to provide feedback information via their user device to a node regarding a quality or rating of data content downloaded.

35. The method for hosting content as claimed in claim 27, wherein a business is a Application Service Provider, said method enabling a user to own, license or rent bandwidth and memory and processing at a node.

36. The method for hosting content as claimed in claim 35, further comprising executing programs, by said Application Service Provider that run on the content cached at the node, said applications and the stored data content fractalized and distributed among a plurality of nodes such that if one node ceases to perform, the application is not lost.
